(19) United States
(12) Patent Application Publication
(10) Pub. No.: US 2003/0055698 A1
(43) Pub. Date: Mar. 20, 2003

(54) Method for predicting and improving the likelihood of success of organization interactions

(76) Inventor: Howard V. Perlmutter, Haverford, PA (US)

Correspondence Address: Robert S. Lipton, LIPTON, WEINBERGER & HUSICK, P.O. Box 934, 201 North Jackson Street, Media, PA, 19063, US

(21) Appl. No.: 10/006,033

(22) Filed: Nov. 16, 2001

Related U.S. Application Data
(60) Provisional application No. 60/249,092, filed on Nov. 16, 2000.

(51) Int. Cl. G06F 17/60

(52) U.S. Cl. 705/7

(57) ABSTRACT

The invention is a method for predicting the likelihood of success of an endeavor by an organization, such as a merger or entry into a new product area, based on a quantification and assessment of the depth of communication within and without the organization. The invention also is a method of improving the likelihood of success of an endeavor by improving communication.

### FIELD OF THE INVENTION

The disclosed invention is a method for predicting and improving the success of interactions among and within organizations, particularly business, governmental and political organizations.

### DESCRIPTION OF THE RELATED ART

As of this writing, recent and spectacular examples of failed communication include the Ford Explorer/Firestone Tire rollover accidents and dual failures of NASA Mars landers. A less spectacular example of failure of communication is that two-thirds of all business mergers fail. The method of the present invention seeks to predict such failures before they occur and to provide organizations, particularly business and governmental organizations, with tools to prevent such failures.

The method of the present invention serves to predict the likelihood of success of an endeavor through evaluating the culture of communication within and without the organization. For example, the present invention may be used to predict the likelihood of success of a merger or alliance between two businesses or to predict the likelihood of success of a business foray into a new product area. The invention also may be used to predict the likelihood of success of an effort to resolve a dispute, such as a political dispute.

The method of the present invention also serves to improve the likelihood of achieving shared or complementary goals by improving communication within and without the organization. For example, the invention can improve the likelihood of success of a merger or a foray into a new market.

### SUMMARY OF THE INVENTION

The present invention is a method for quantifying, evaluating and improving dialog within and without an organization for the purpose of assisting the organization in accomplishing its goals. For the purposes of this application, the term “dialog” means communications among persons, such communications being classified by the nature and quality of the communication.

In the method of the present invention, an investigator collects data on “dialog drivers” and “dialog deficits,” as those terms are hereinafter defined, from persons subject to the inquiry. The investigator may collect the information by any combination of methods available, including without limitation electronic questionnaires, paper questionnaires and personal interviews.

The investigator evaluates the collected information statistically to determine an “organization profile.” The organization profile summarizes the nature and quality of dialog for the organization as a whole or as it relates to a particular organization endeavor, such as a merger or alliance.

An organization exhibits predictable characteristics, or a “culture of communication,” that is revealed by the organization profile. Based on those predictable characteristics, the investigator can diagnose the organization and predict the likelihood of success or failure of a specific endeavor or of the entire organization.

For example, the investigator can determine whether a cultural mismatch exists between the organization and its environment. A common example is an ethnocentric organization newly competing in a global market. Although the organization profile may reveal excellent dialog characteristics among persons within the organization, those same dialog characteristics may be very poor for stakeholders from other cultures.

The organization profile also reveals steps that the organization may take to reinforce dialog drivers and decrease dialog deficits at different levels and depths. The organization may thereby improve the nature and quality of dialog, change its profile, and improve the likelihood of success of its endeavors.

In the broadest sense, the present invention aids in the achievement of the goals of an organization through the creation of an appropriate organizational “social architecture.” The term “social architecture” means the art and discipline of embodying social values in organizational structures. On the largest scales, the term “social architecture” incorporates roles created by the various governmental, societal and social rules. In the commercial context, the term includes the roles of individuals and teams within a business organization and the organizational structure as a whole.

The social architecture best suited to accomplishing shared or complementary business or governmental goals is a “collaborative social architecture.” The term “collaborative social architecture” means the design of roles of persons in an organization, and hence of teams and other units within the organization, that embodies the enhanced dialog and communications concepts of the present invention.

### BRIEF DESCRIPTION OF THE DRAWINGS

FIG. 1 is a flow chart illustrating the present invention.

FIG. 2 is a list of the “dialog drivers.”

FIG. 3 is a list of “dialog deficits.”

FIG. 4 is a list and description of the three levels of depth in dialog.

FIG. 5-1 to FIG. 5-19, comprising nineteen pages, is a first example of a questionnaire used to elicit dialog information.

FIG. 6-1 to FIG. 6-9, comprising nine pages, is a second example of a questionnaire used to elicit dialog information.

FIG. 7 is a third example of a questionnaire used to elicit dialog information.

FIG. 8-1 to FIG. 8-52 is a training manual for use in teaching persons to improve depth of communication.

FIG. 9-1 to FIG. 9-18 is a manual for trainers teaching other persons to improve depth of communication.

FIG. 10-1 to FIG. 10-18 is a diary for training purposes.

### DESCRIPTION OF THE PREFERRED EMBODIMENT

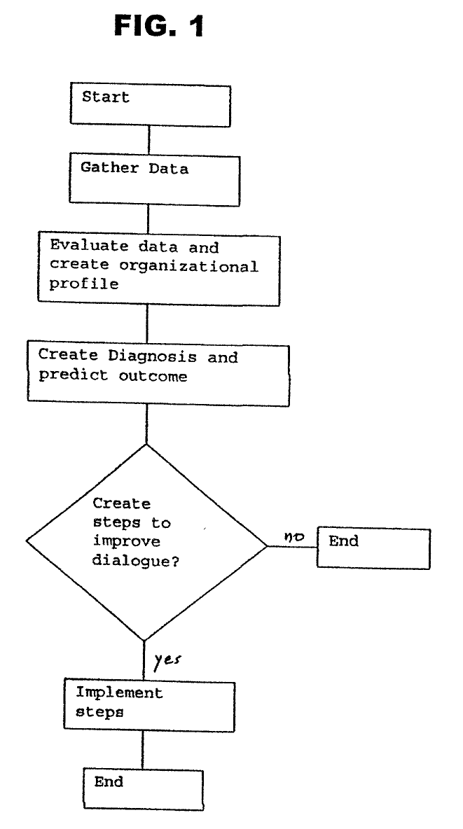

In the preferred embodiment, and as shown by FIG. 1, an investigator gathers data concerning the quality and nature of communication (“communication information”). Depending upon the specific area of inquiry involved, the data are collected from among persons within an organization or a portion of an organization, from stakeholders outside the organization, or from any combination of the foregoing. The term “stakeholders” means customers, clients, suppliers, members of a community regulated by the organization, or any other person with whom the organization may interact.

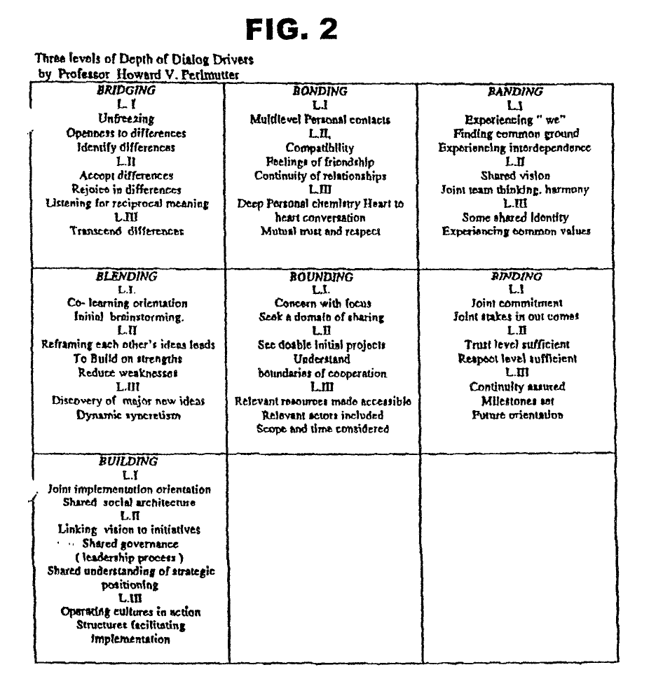

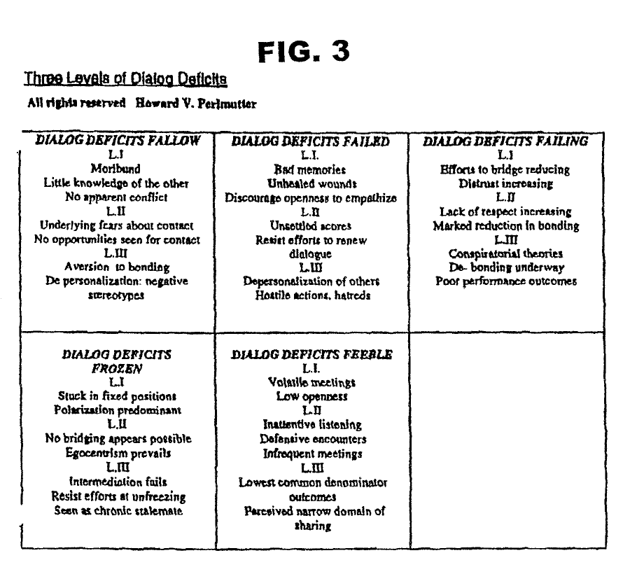

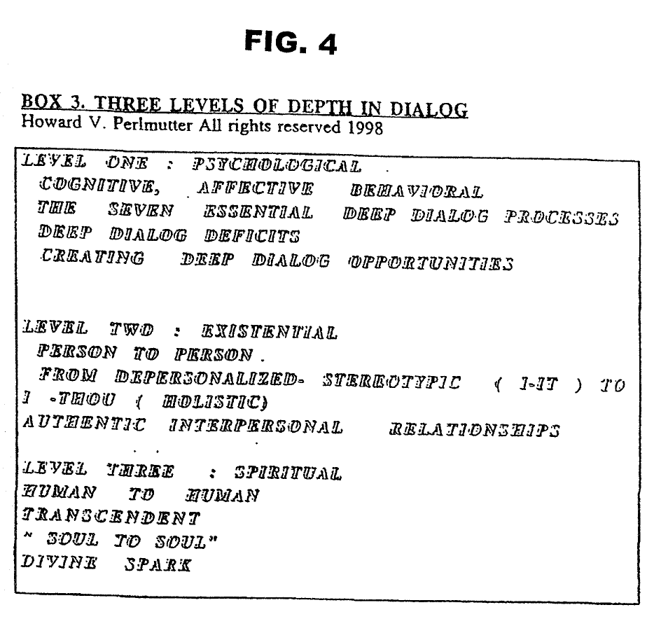

The data comprise information about the culture of communication within and without the organization. In the preferred embodiment and as illustrated by FIGS. 2 and 3, the data are organized according to seven “dialog drivers,” also referred to as “dialog competencies,” and five “dialog deficits.” “Dialog drivers,” or “dialog competencies,” are those factors that serve to promote a greater depth of dialog, as illustrated by FIG. 4. Communication at a greater depth (level three rather than level one of FIG. 4.) serves to increase the likelihood that an organization, or an undertaking of an organization, will be successful. FIGS. 2 and 3 list examples of the three depths of dialog of FIG. 4 as applied to each of the dialog drivers (“dialog driver levels”) and dialog deficits (“dialog deficit levels”) of the preferred embodiment.

In the preferred embodiment, there are seven dialog drivers, five dialog deficits and three depths of communication. In alternative embodiments, the categories of dialog drivers, dialog deficits and depths of communication may be combined to create fewer categories, or subdivided to create more categories.

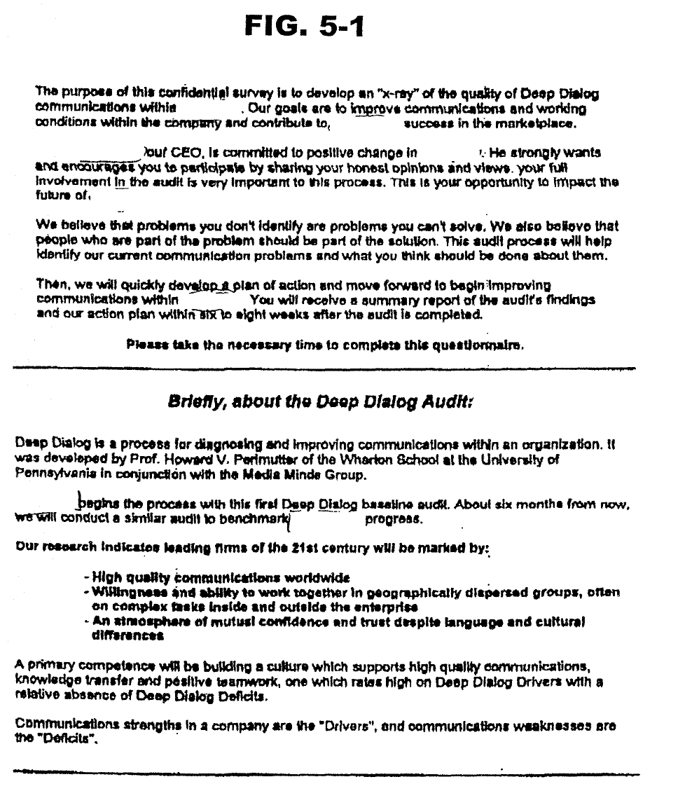

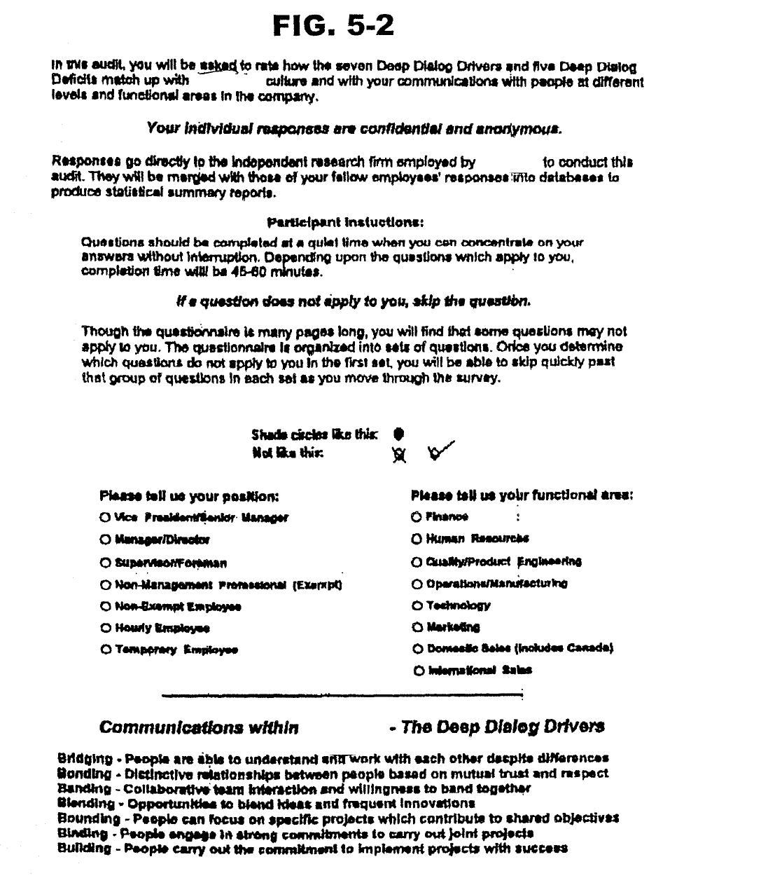

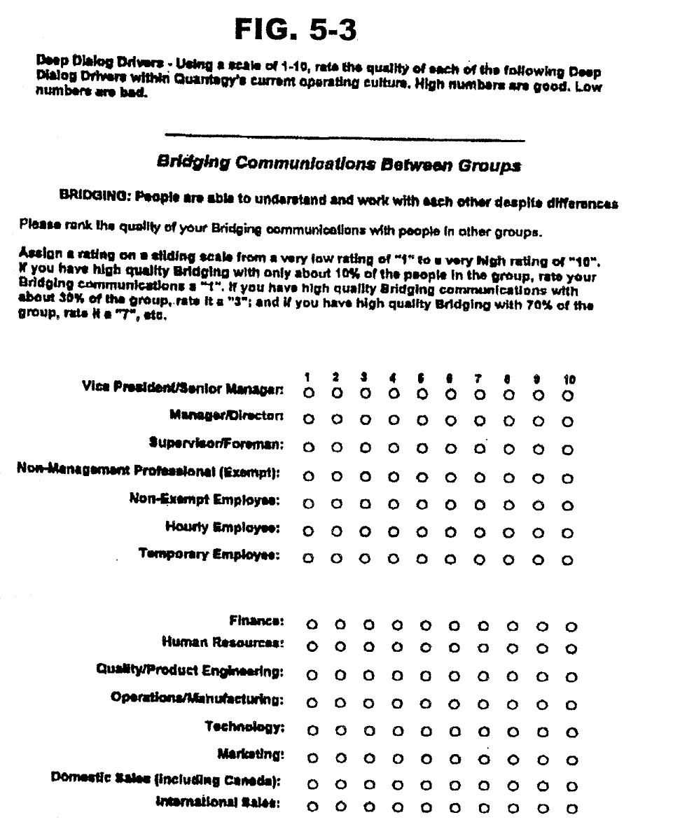

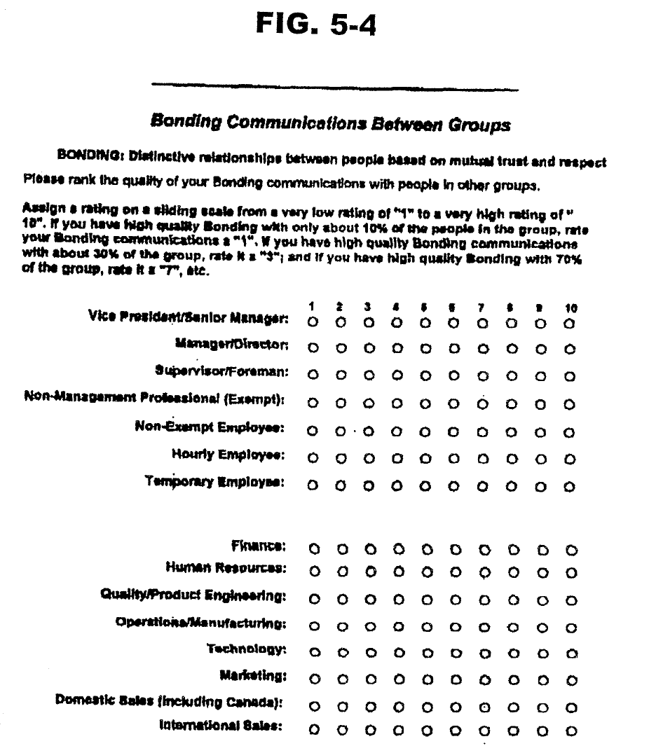

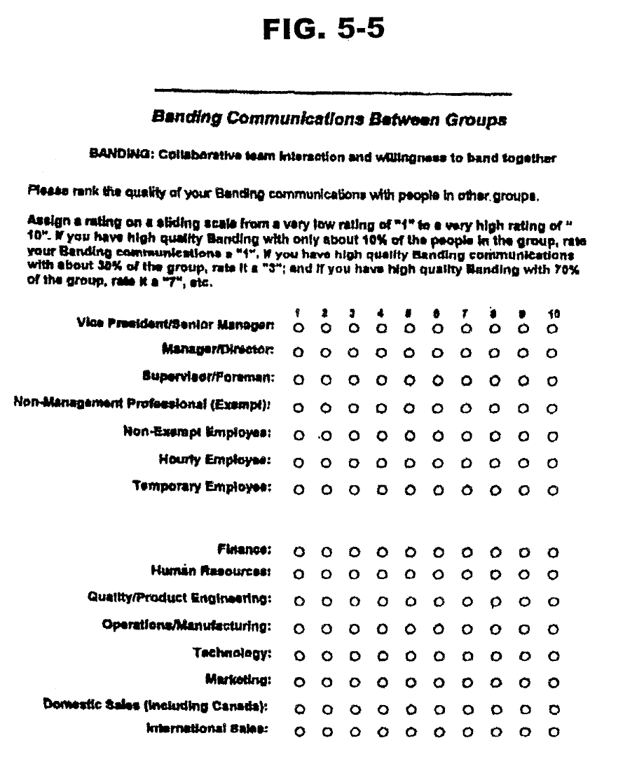

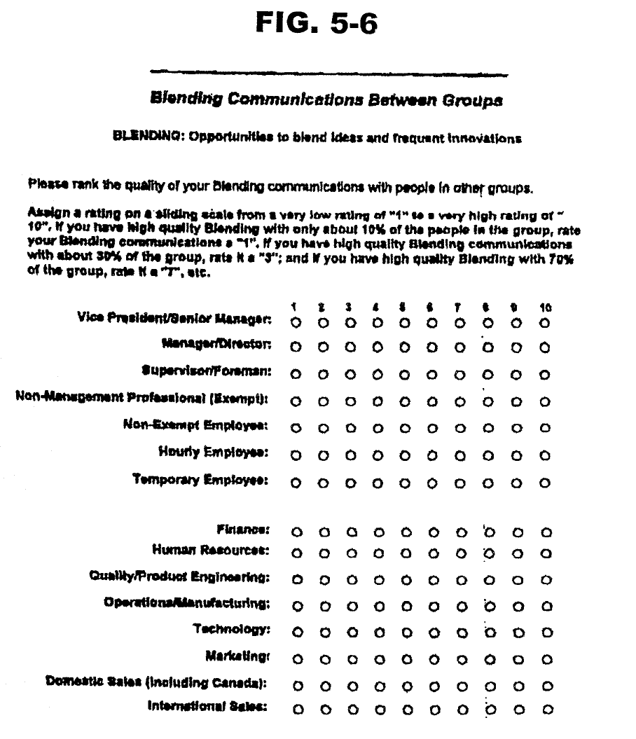

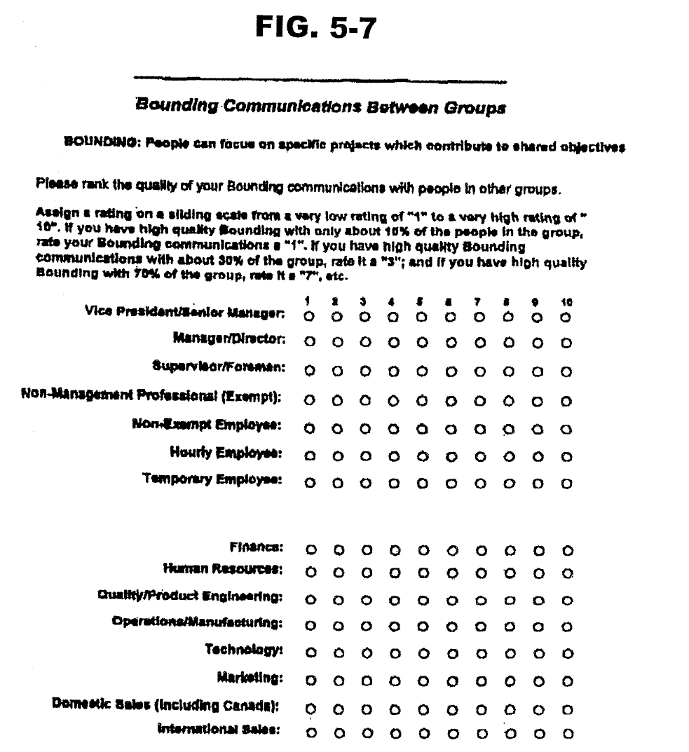

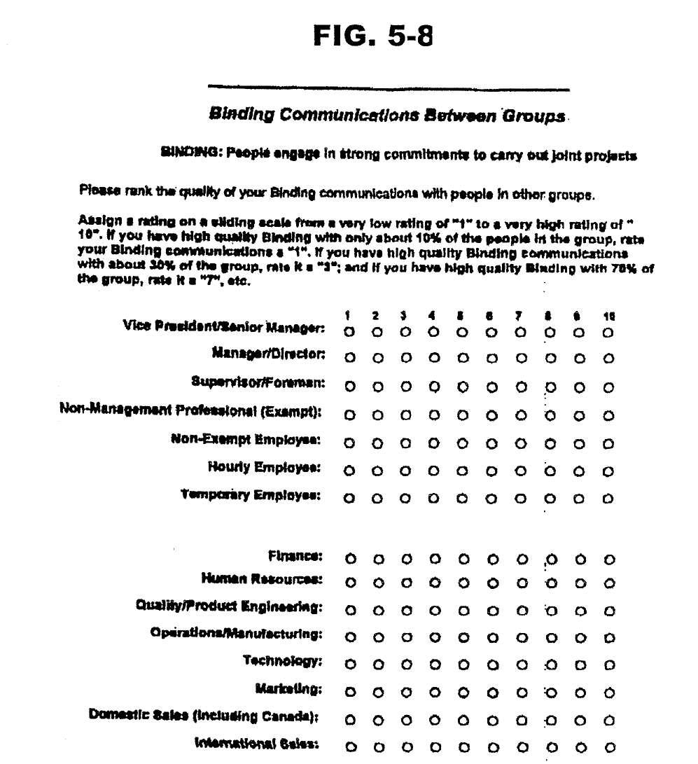

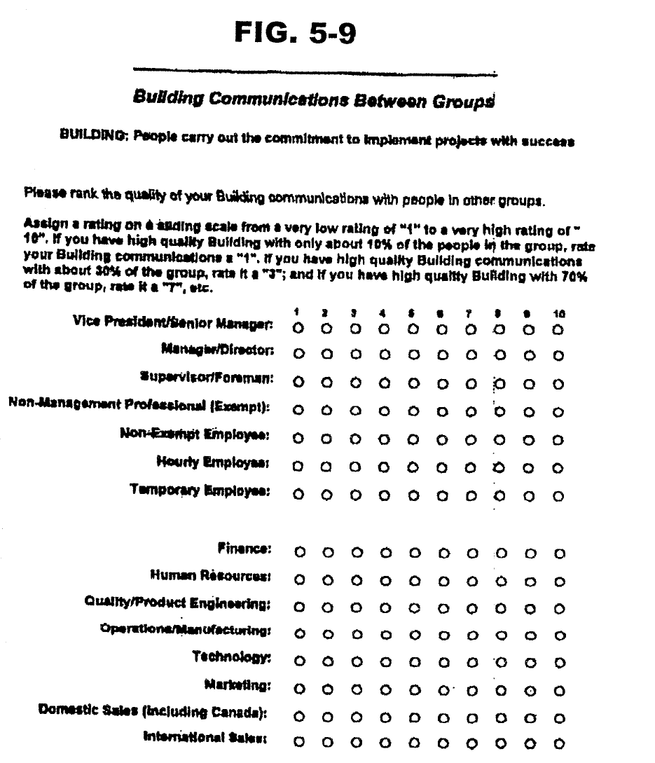

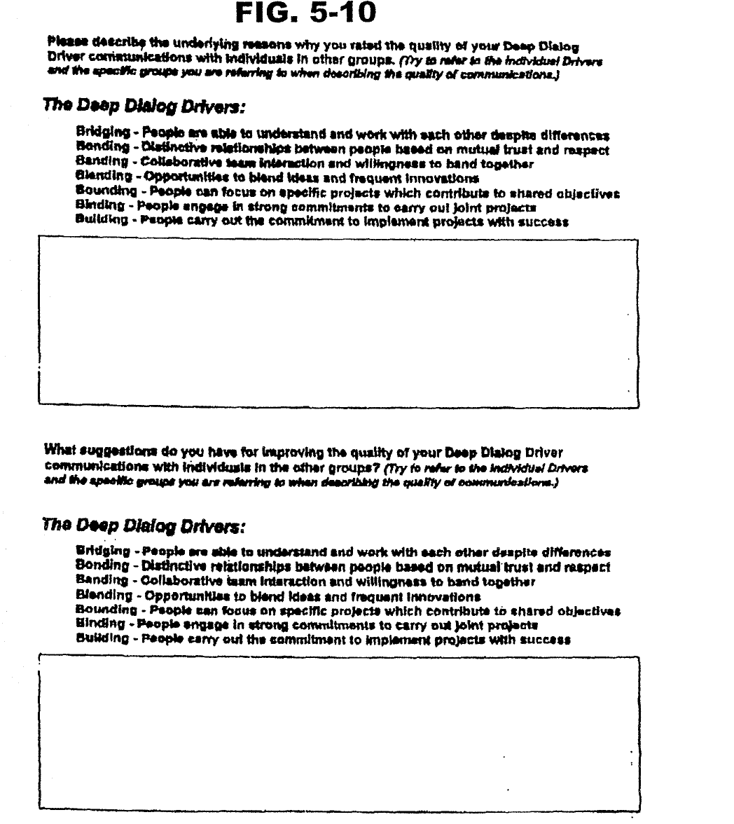

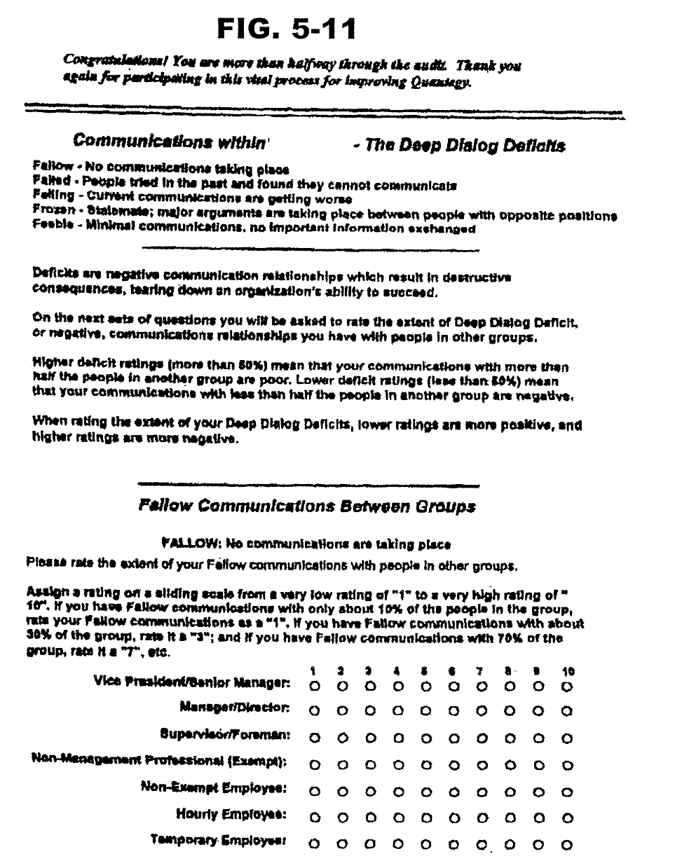

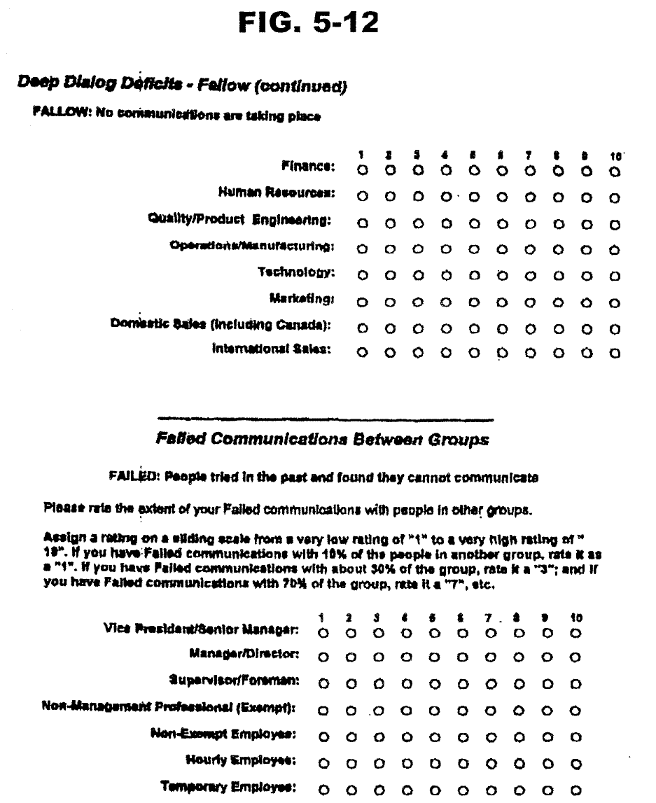

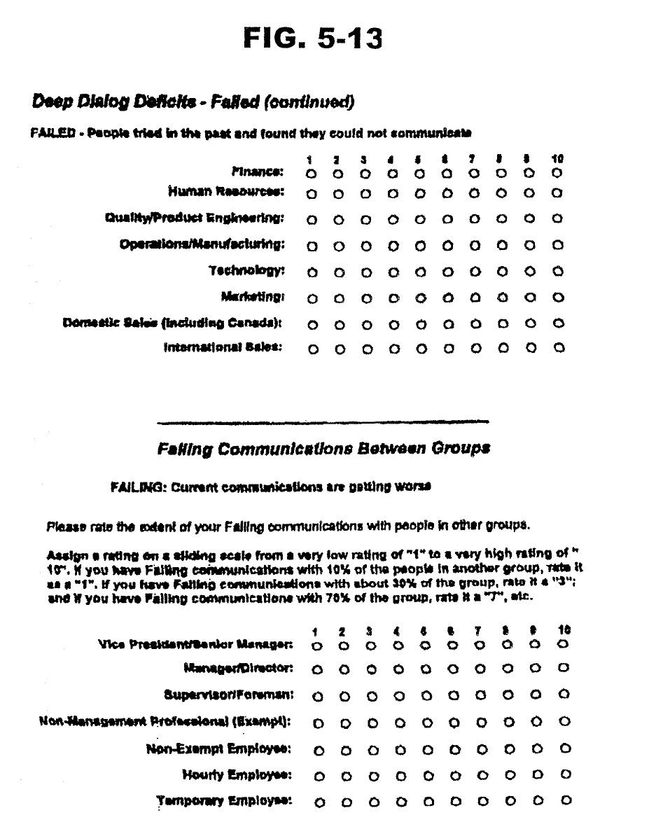

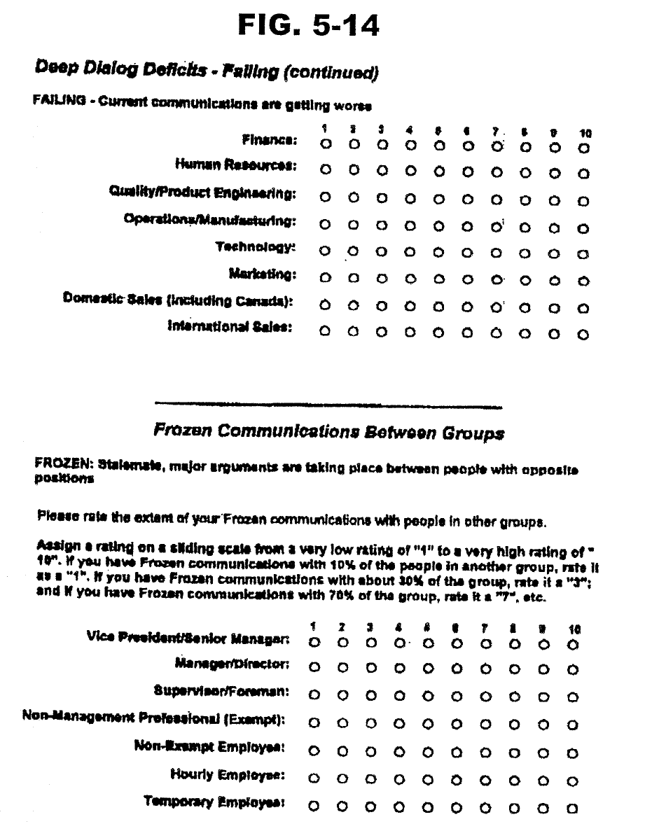

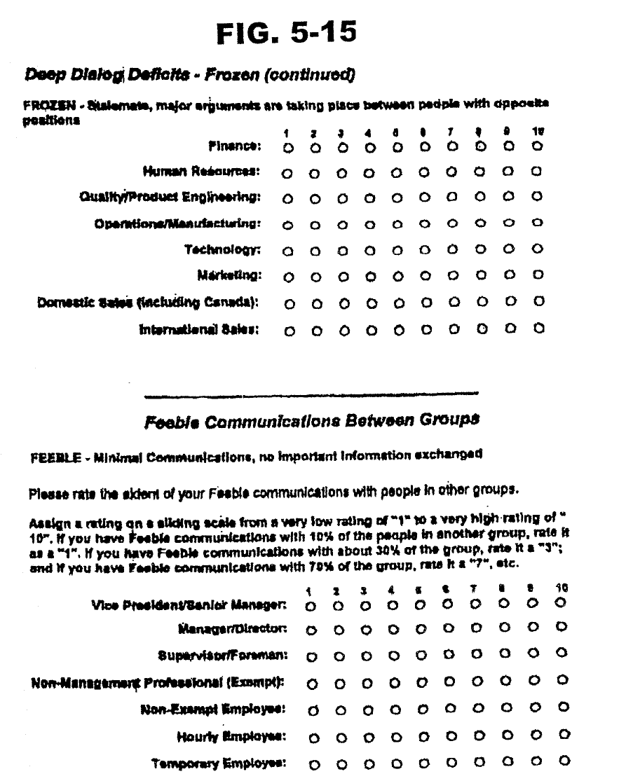

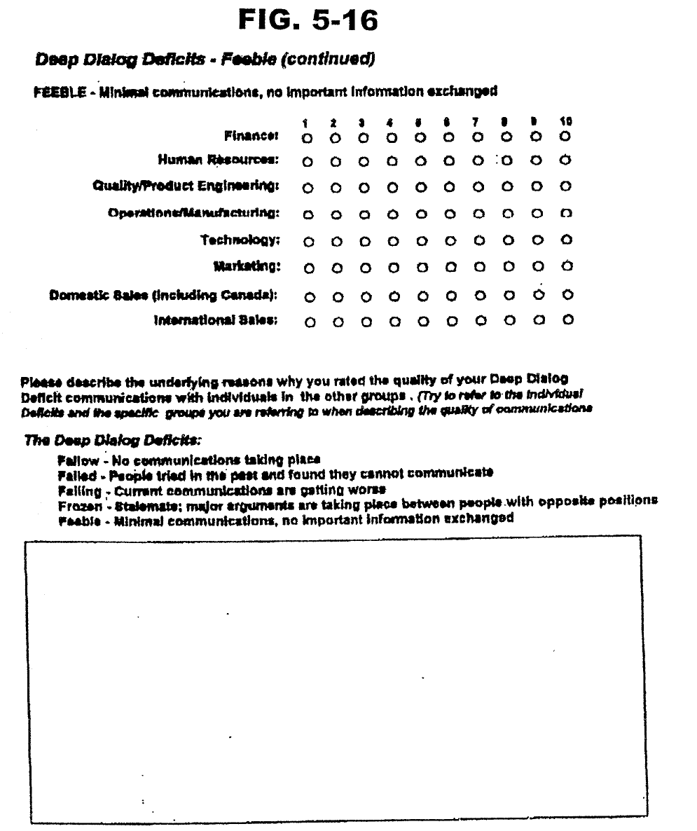

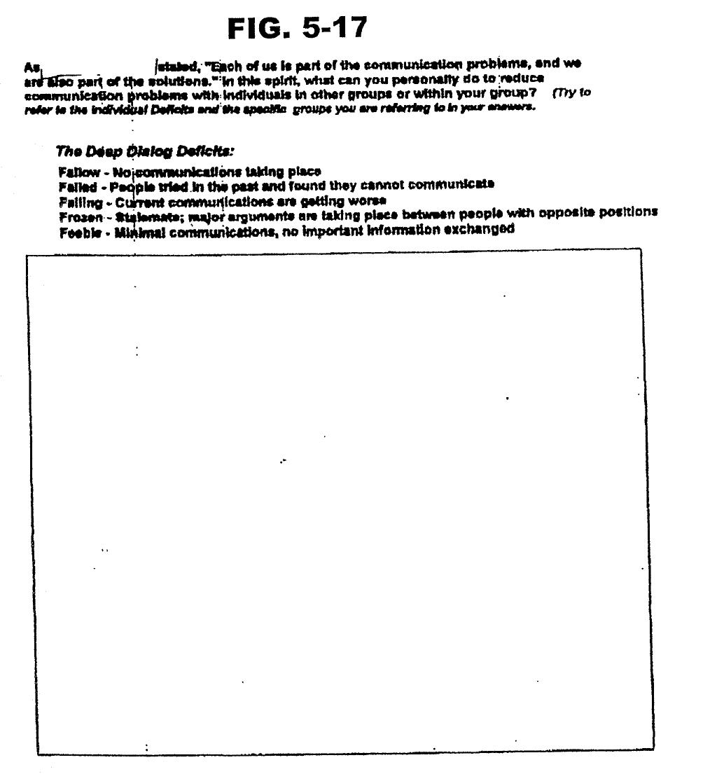

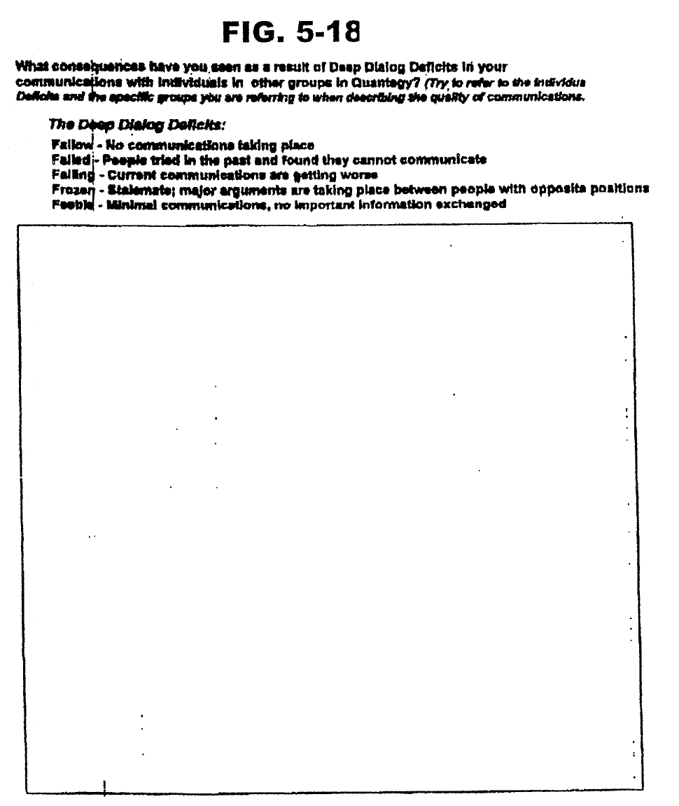

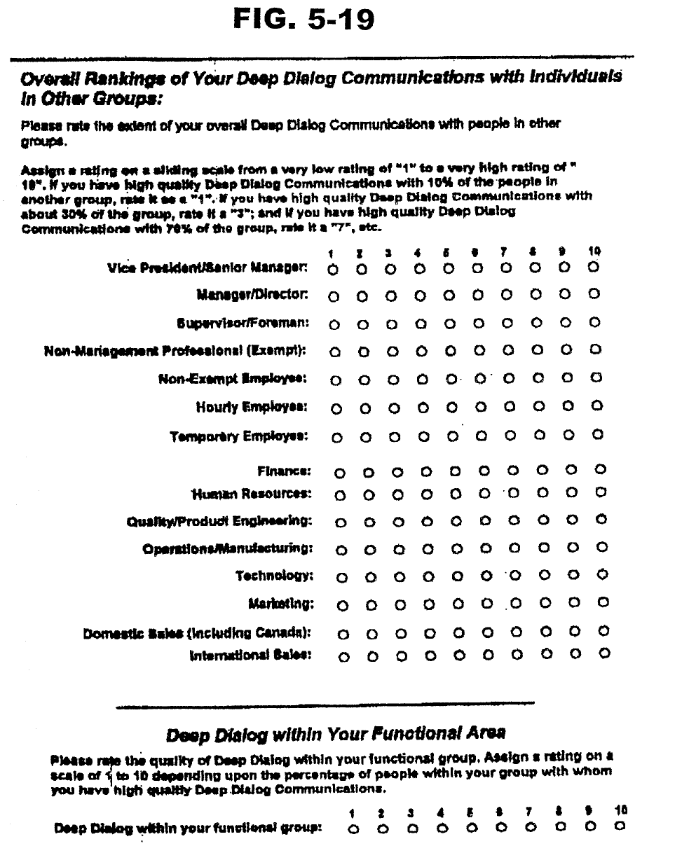

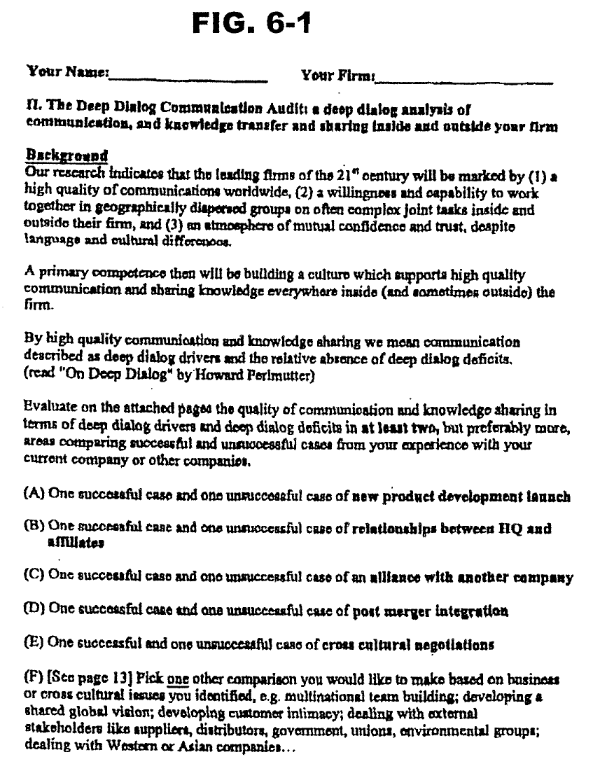

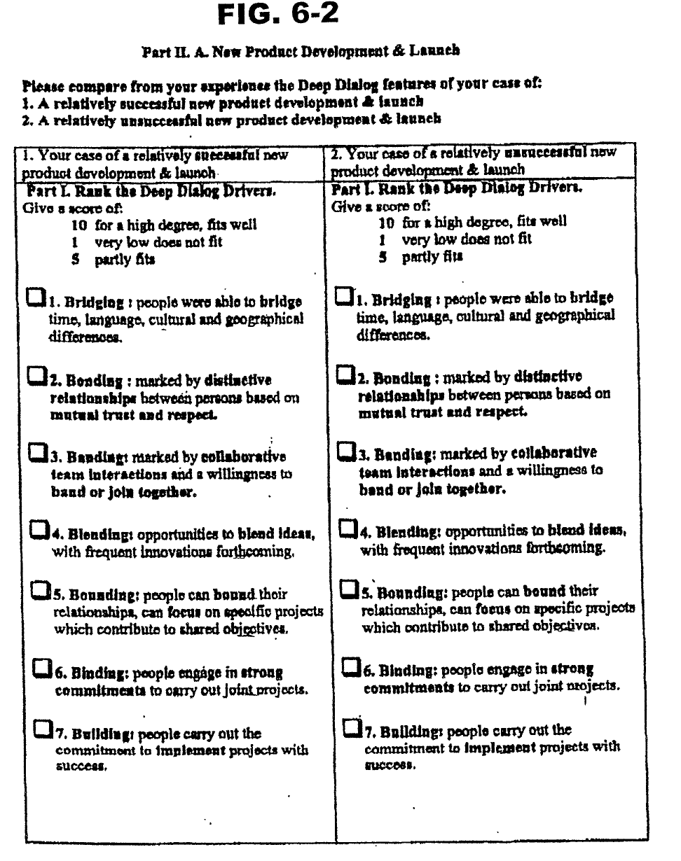

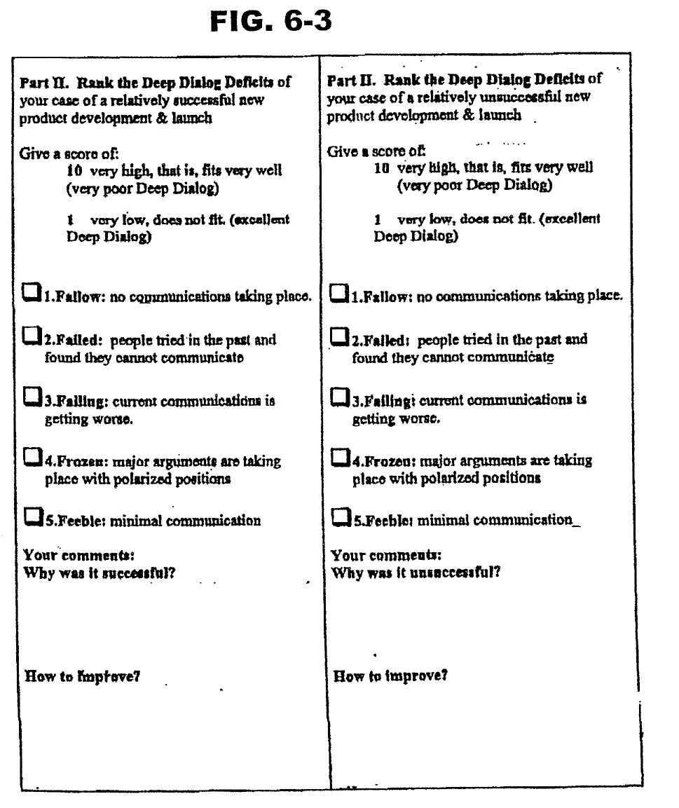

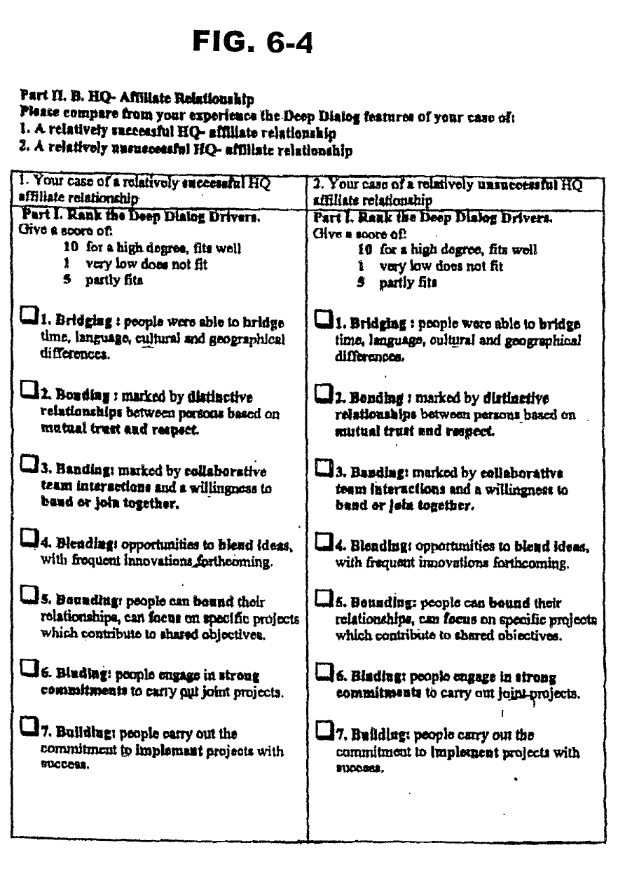

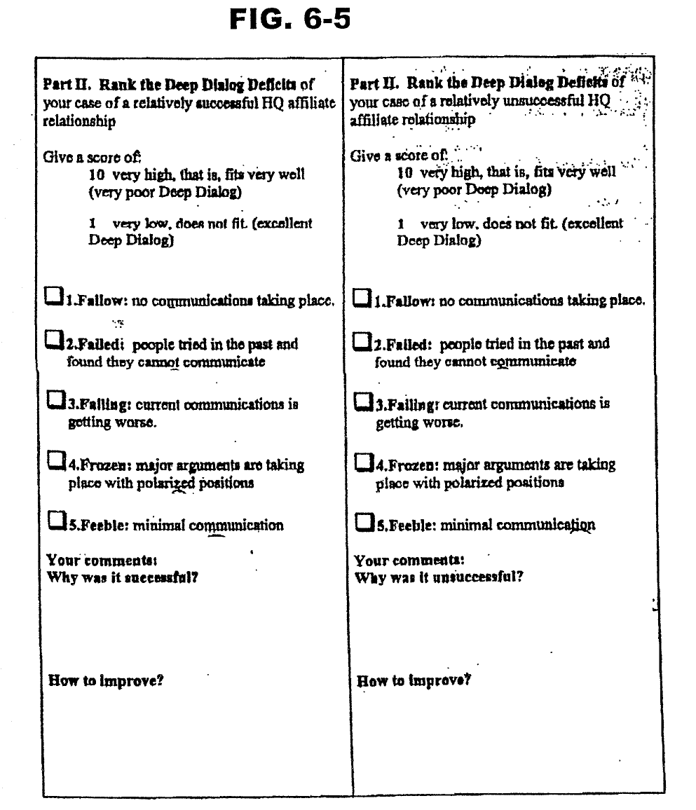

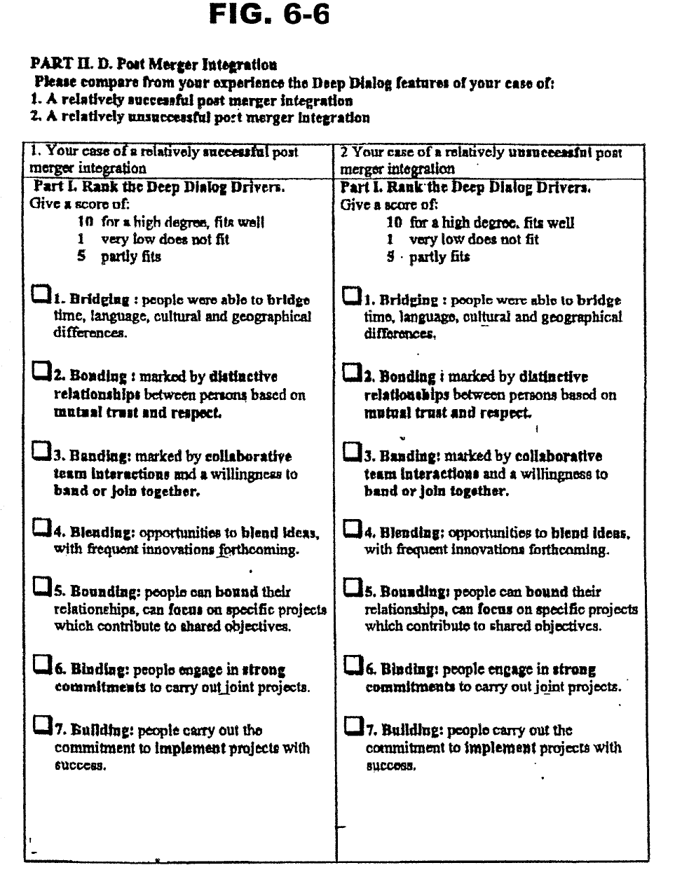

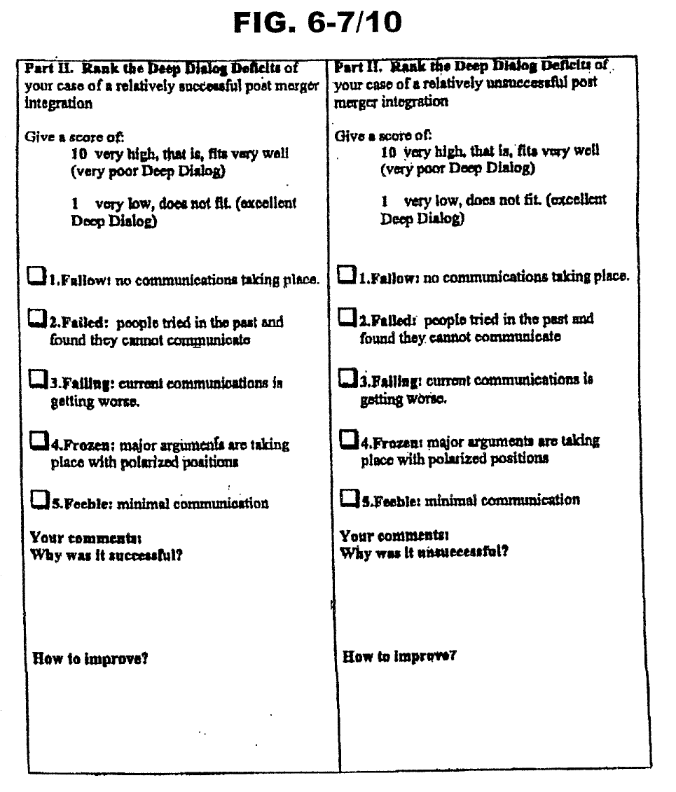

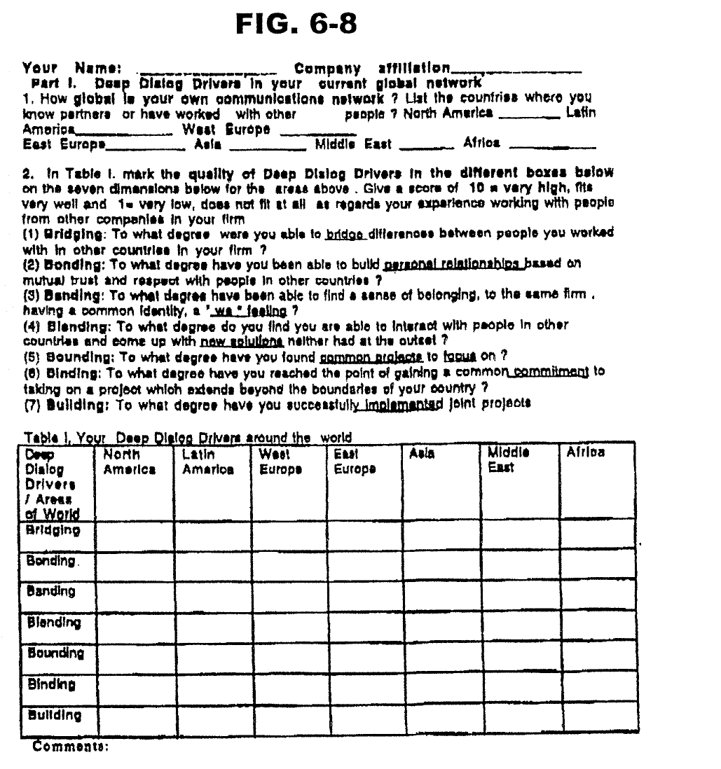

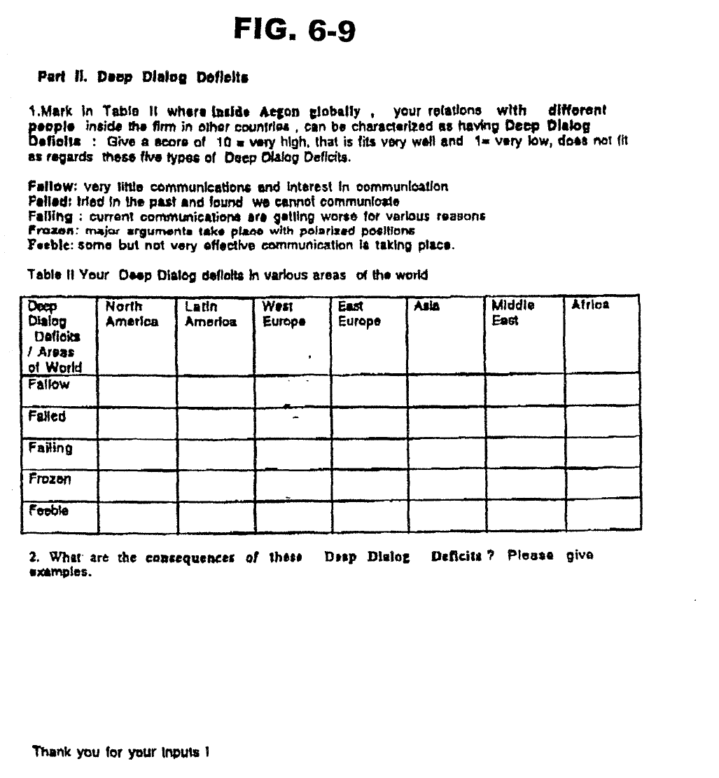

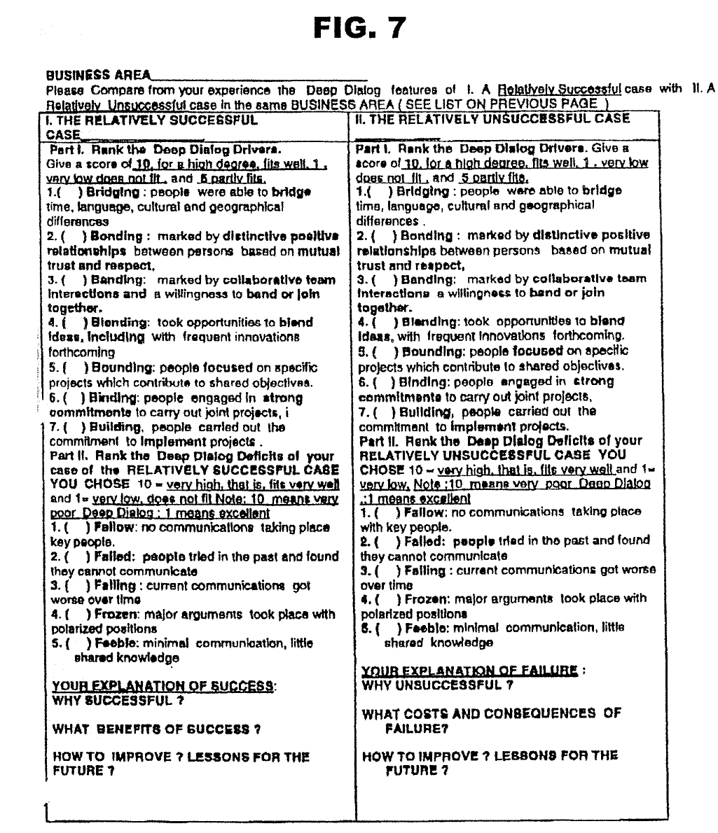

The data may be collected using any means available for collecting such data, such as electronic or paper questionnaires or personal interviews. The Internet is a particularly useful tool for presenting questionnaires and collecting data. FIGS. 5 through 7 are examples of paper questionnaires.

As illustrated by FIGS. 5 through 7, in the preferred embodiment, a participant is requested to rank each of the dialog drivers (FIG. 2) and dialog deficits (FIG. 3) on a scale of one to ten. Although a ranking of one to ten is preferred, any graduated ranking system having any number of graduations may be utilized. The participant is provided with guidance (FIGS. 5,6) in assigning a ranking to each factor.

The completed questionnaires (FIGS. 5 through 7) are returned to the investigator, who evaluates the data. Evaluation of the data involves extracting statistical information. In the preferred embodiment the extracted information is the mean of the responses for each question with the response of each of the persons surveyed receiving equal weight. The resulting mean of each of the responses is the “organization profile.” The organization profile reveals the organization's culture of communication.

Experience has shown that questionnaire responses within an organization are remarkably consistent from one person to another, regardless of the position in the organizational hierarchy occupied by that person. Whether articulated or not, an organization's culture of communication is apparent to everyone within the organization.

The investigator utilizes judgement and compares the “organization profile” to predetermined criteria to diagnose the organization. In the preferred embodiment, a mean ranking of less than seven for dialog drivers or a mean ranking of more than three for dialog deficits indicates that communication is deficient and that the achievement of the goals of the organization may be in jeopardy.

The investigator may examine an entire organization or may refine the examination by any extent desired, as by comparing rankings for one or more of the dialog drivers and deficits among subdivisions of the studied organization. The investigator may determine which of the dialog deficits and drivers are considered the most important by different persons, as for example the clients or customers of a business organization, and may provide particular emphasis to those dialog drivers or deficits. The investigator may compare the mean ranking for dialog drivers and deficits for an organization to the corresponding rankings of other organizations, such as organizational peers of the studied organization.

From the diagnosis, the investigator can predict the success of an endeavor of the organization, such as a merger or alliance, or can predict the overall success of all or part of the organization. If a prediction is all that is required the investigator's inquiry stops here.

If the organization is committed to effectuating a collaborative social architecture and hence improving the organization profile, the investigator and the organization will use the profile to develop specific steps that may be implemented by the organization. The purpose of the steps specifically will be to reinforce dialog drivers and decrease dialog deficits. Such steps exist on multiple levels and are not mutually exclusive.

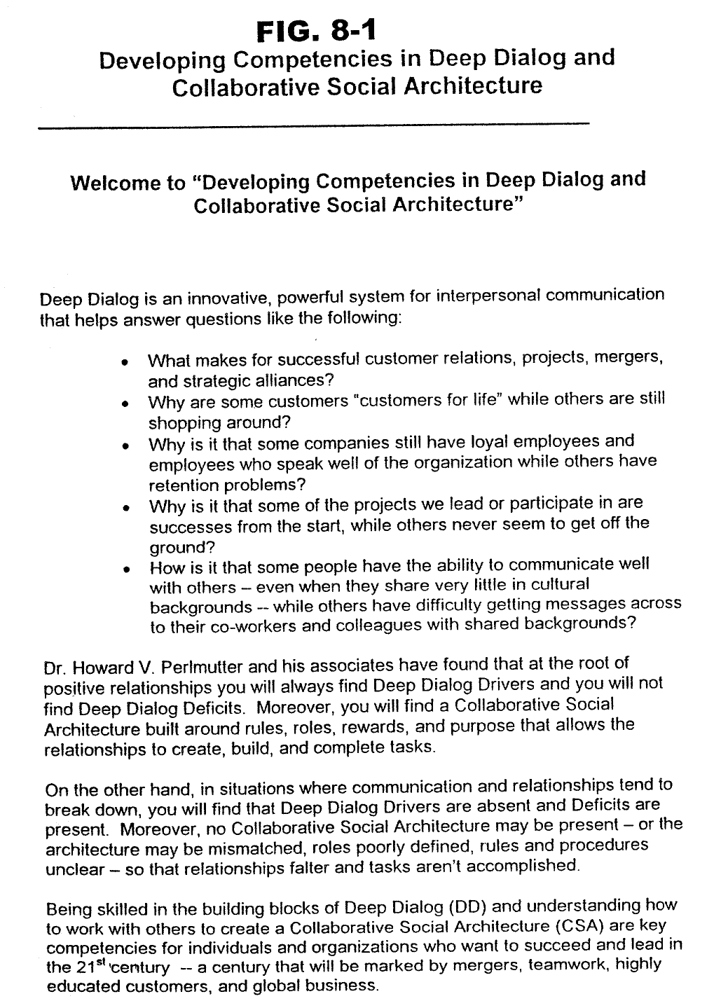

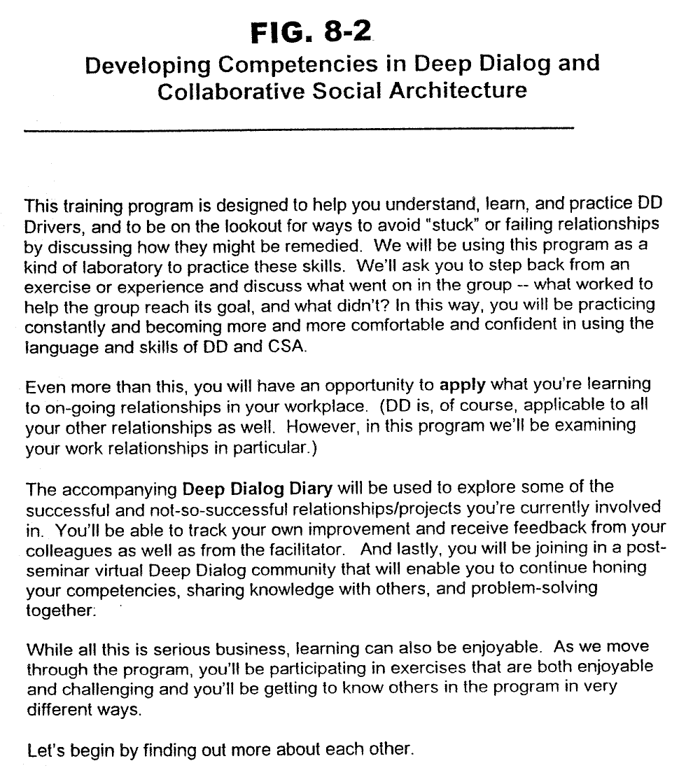

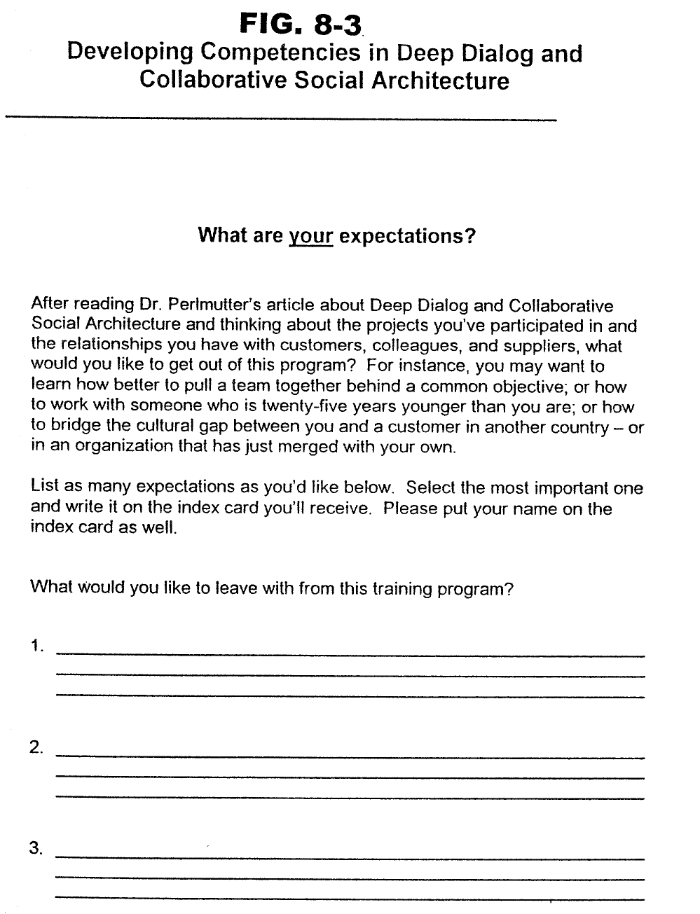

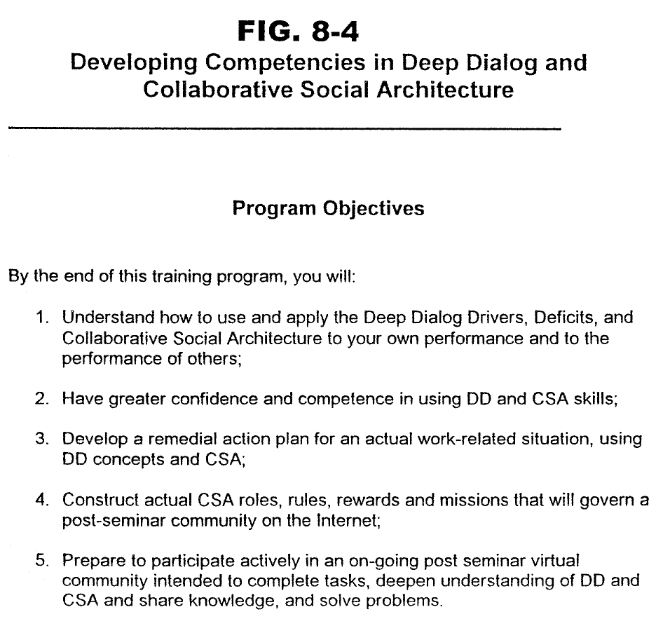

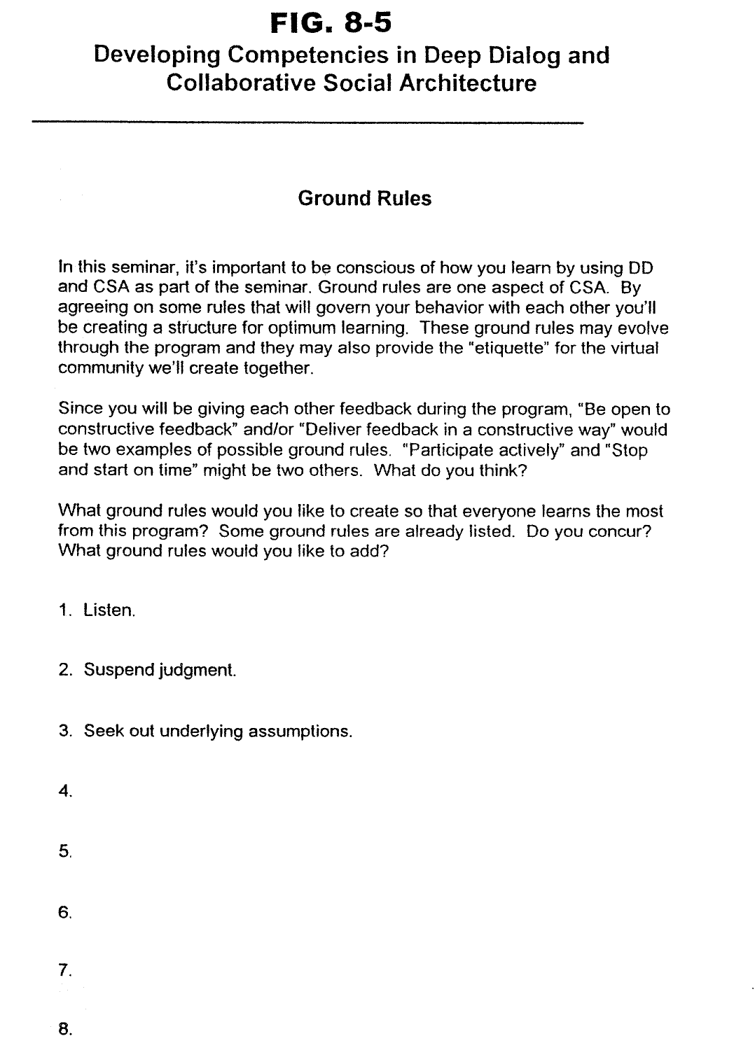

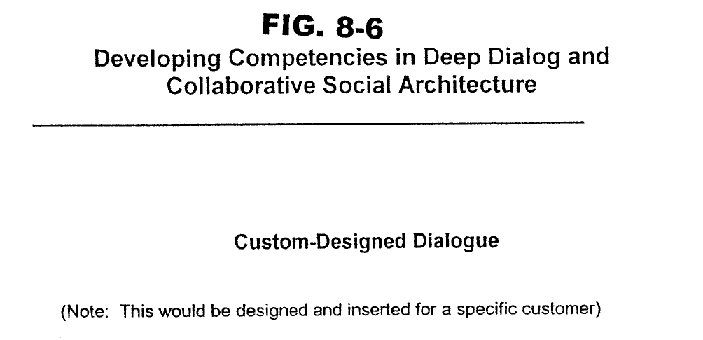

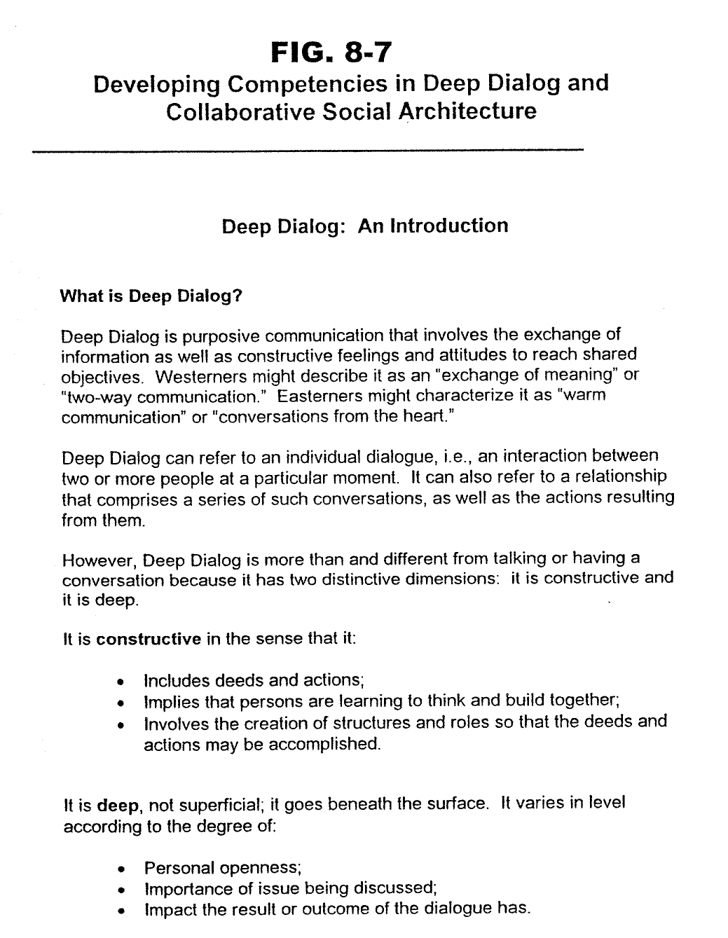

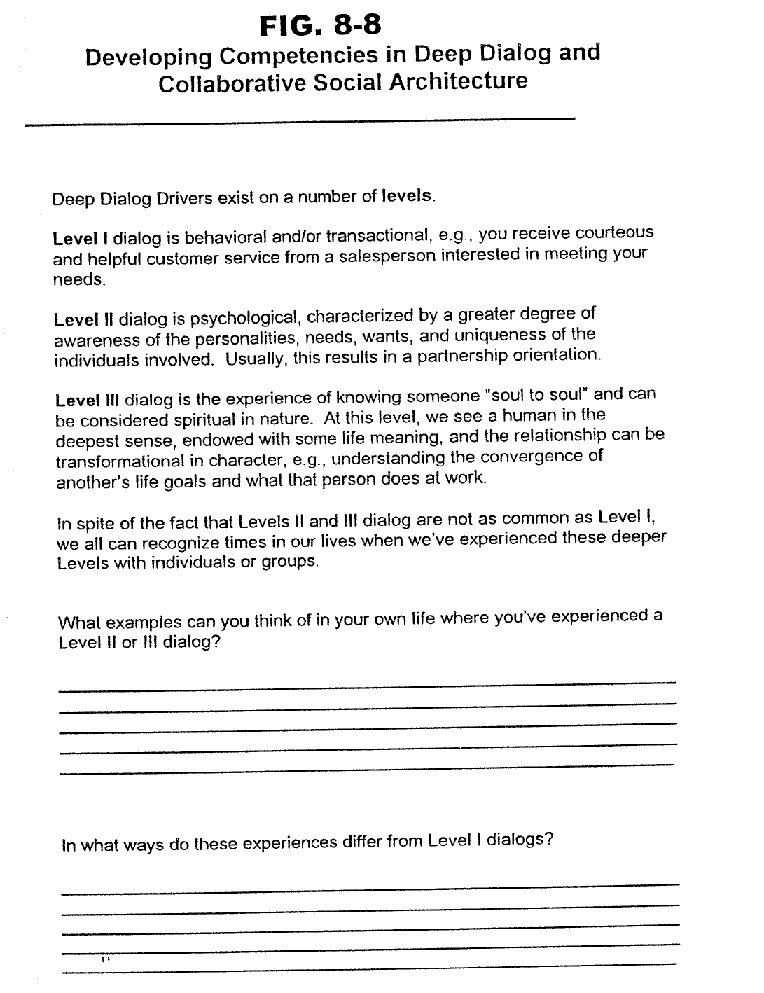

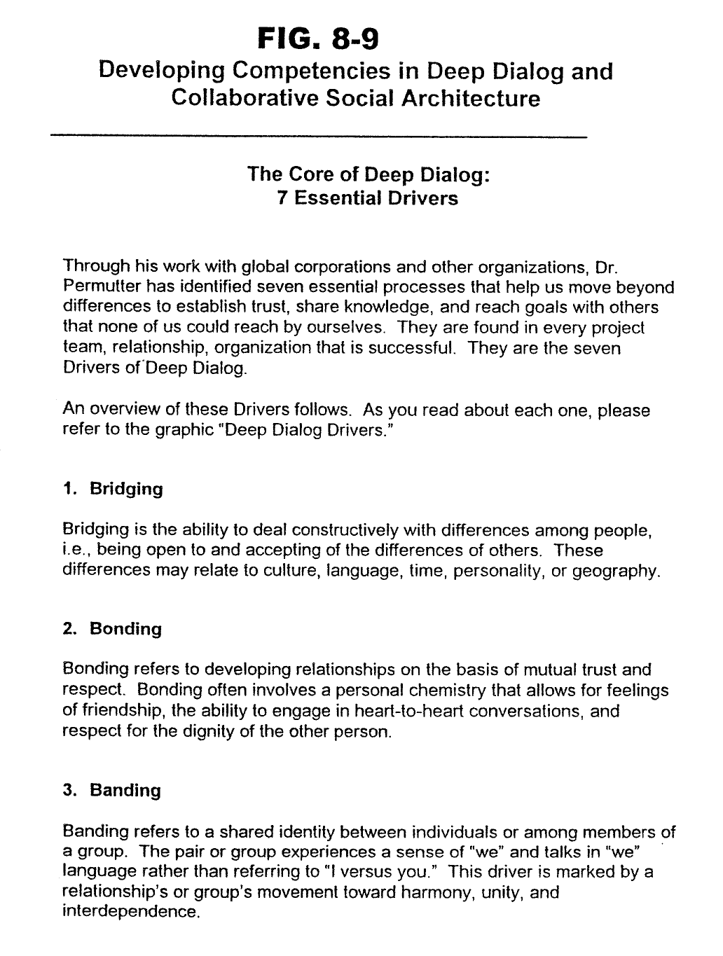

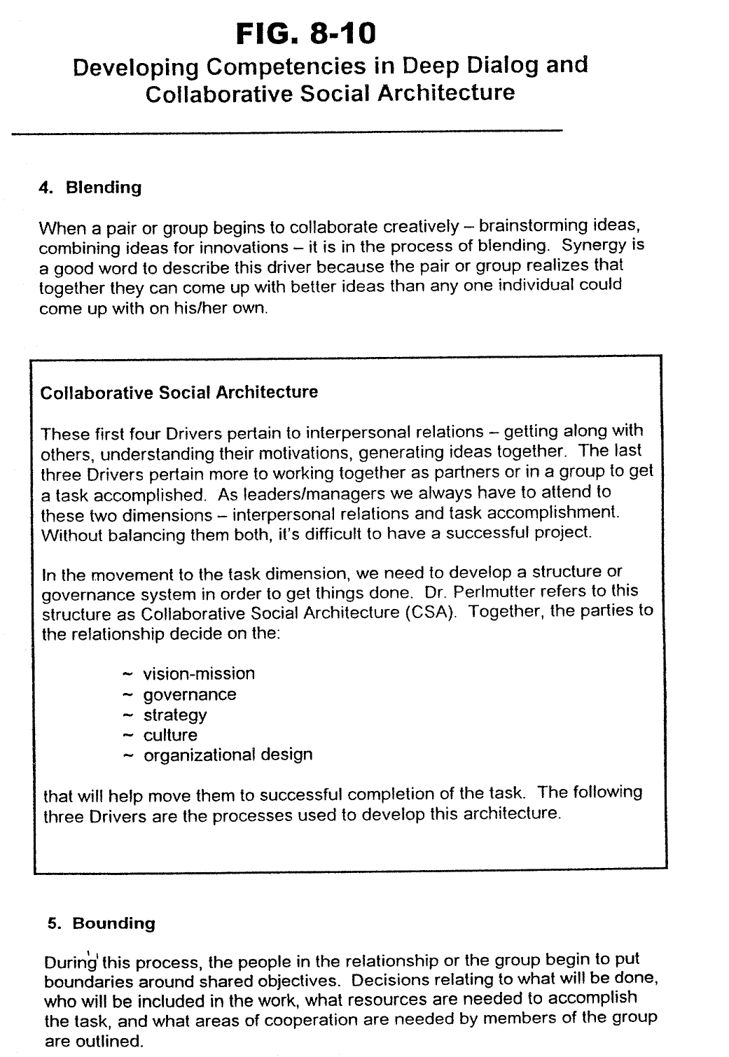

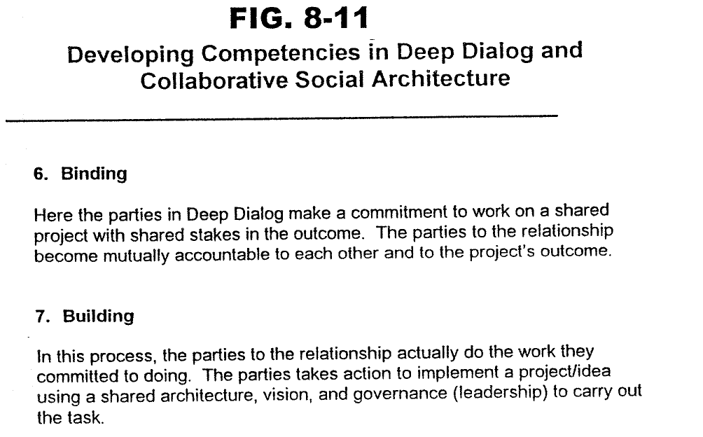

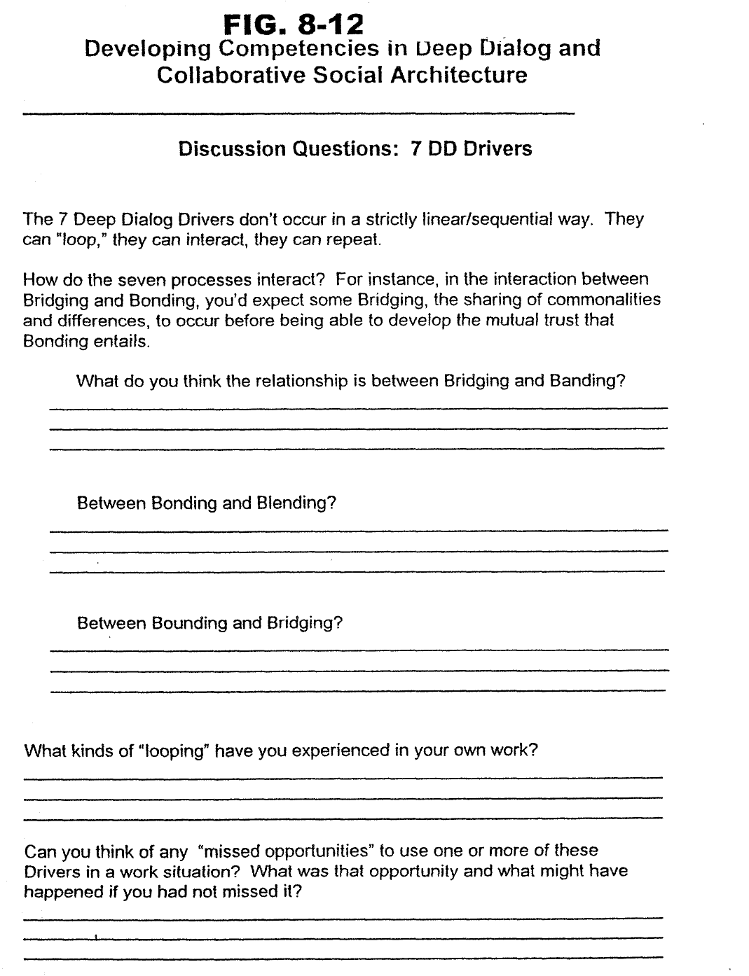

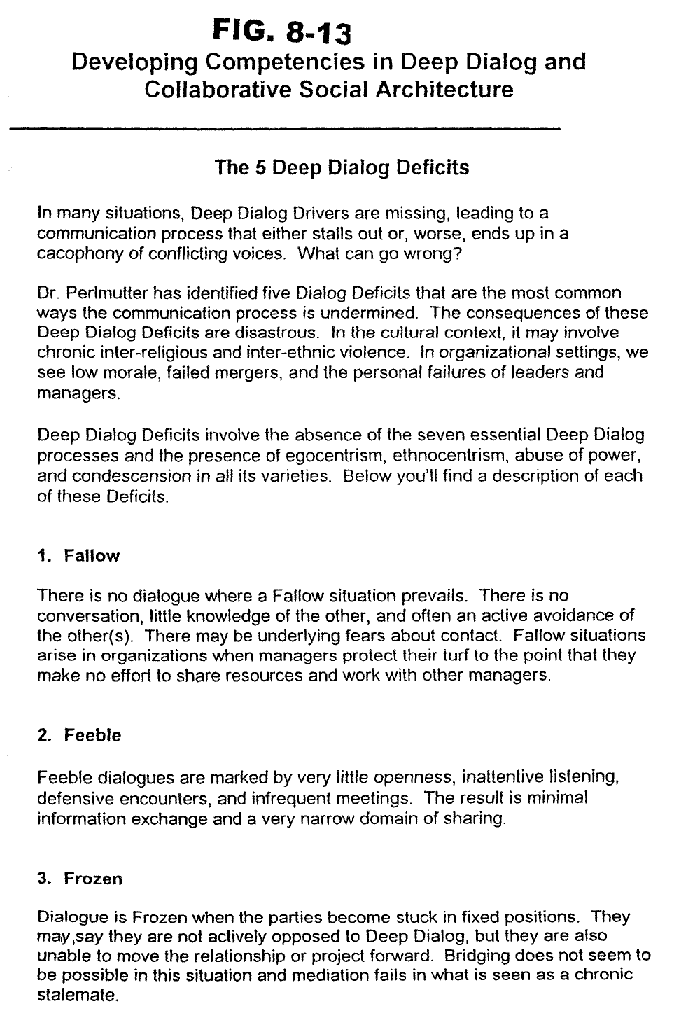

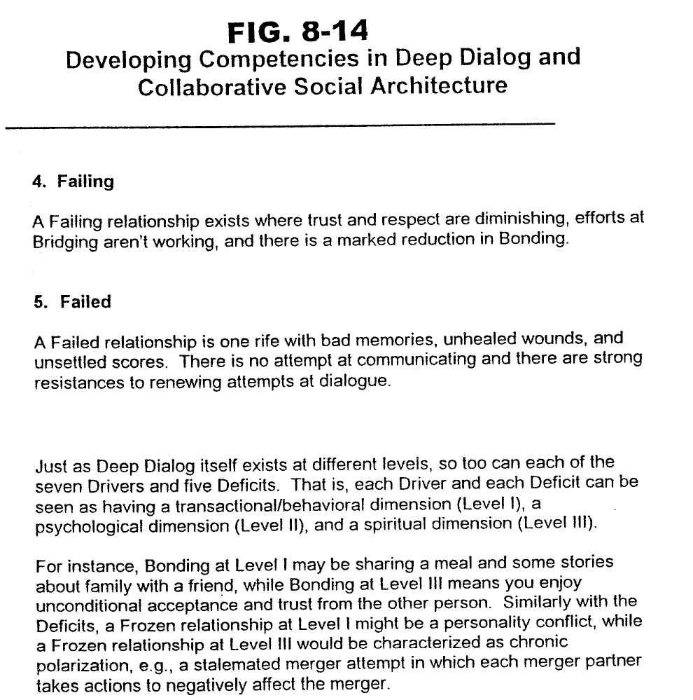

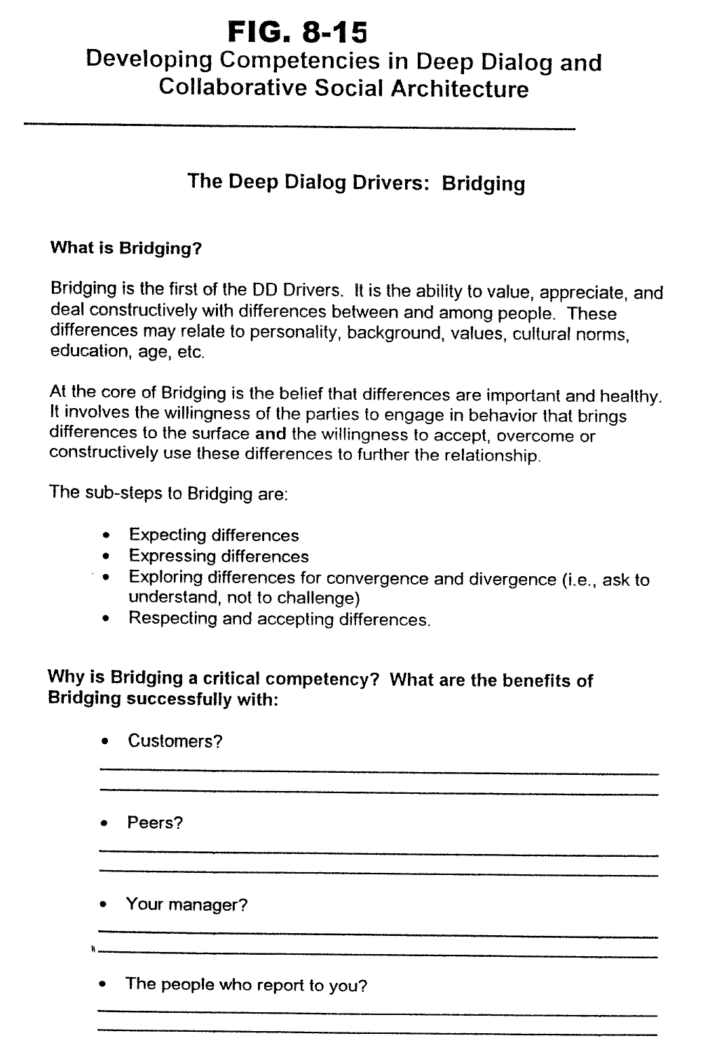

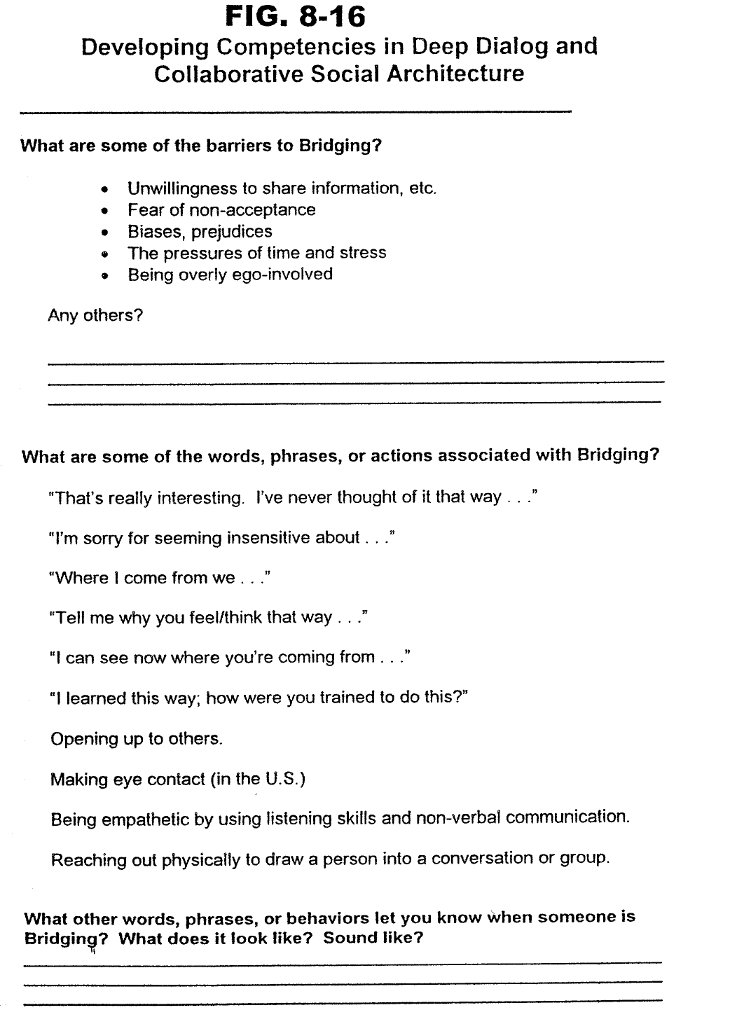

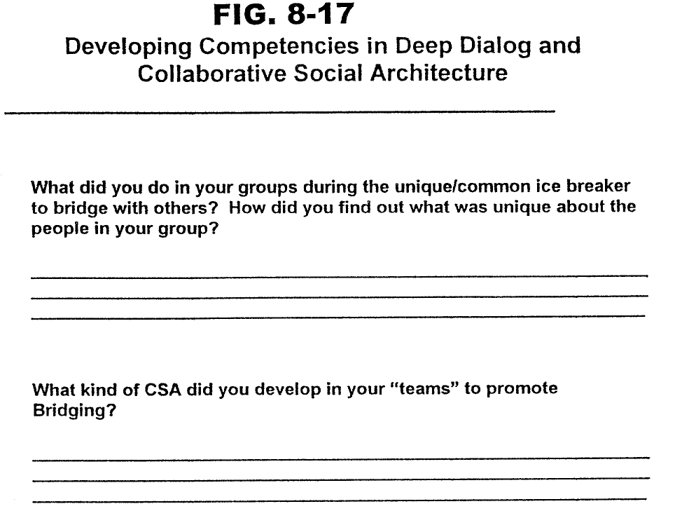

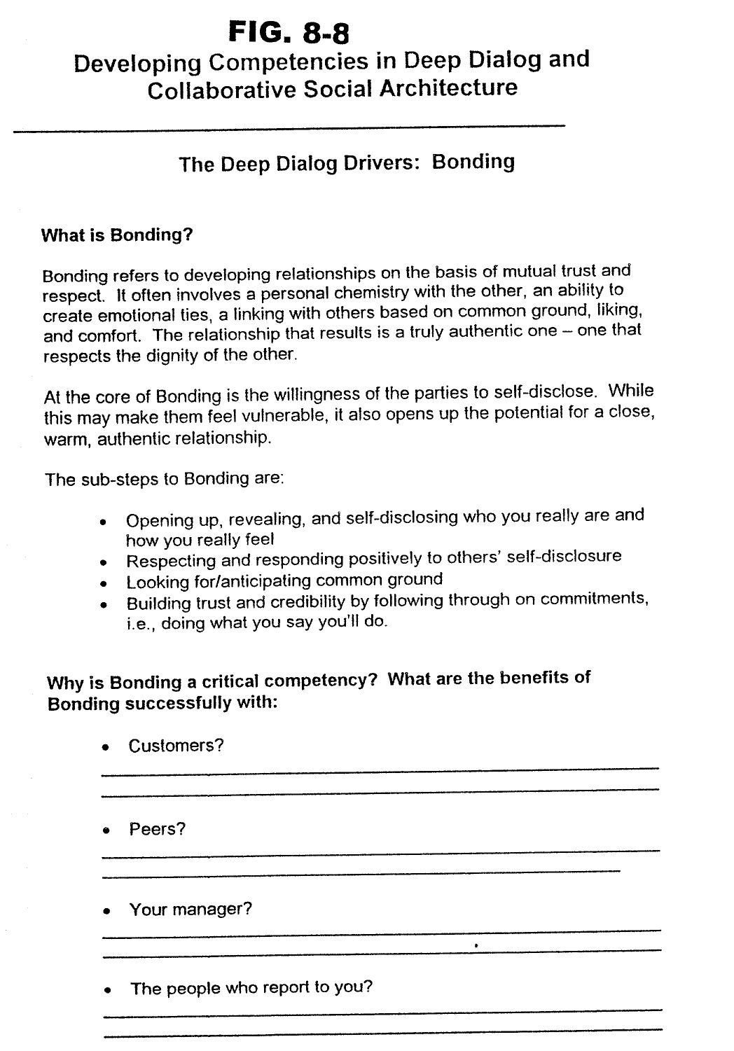

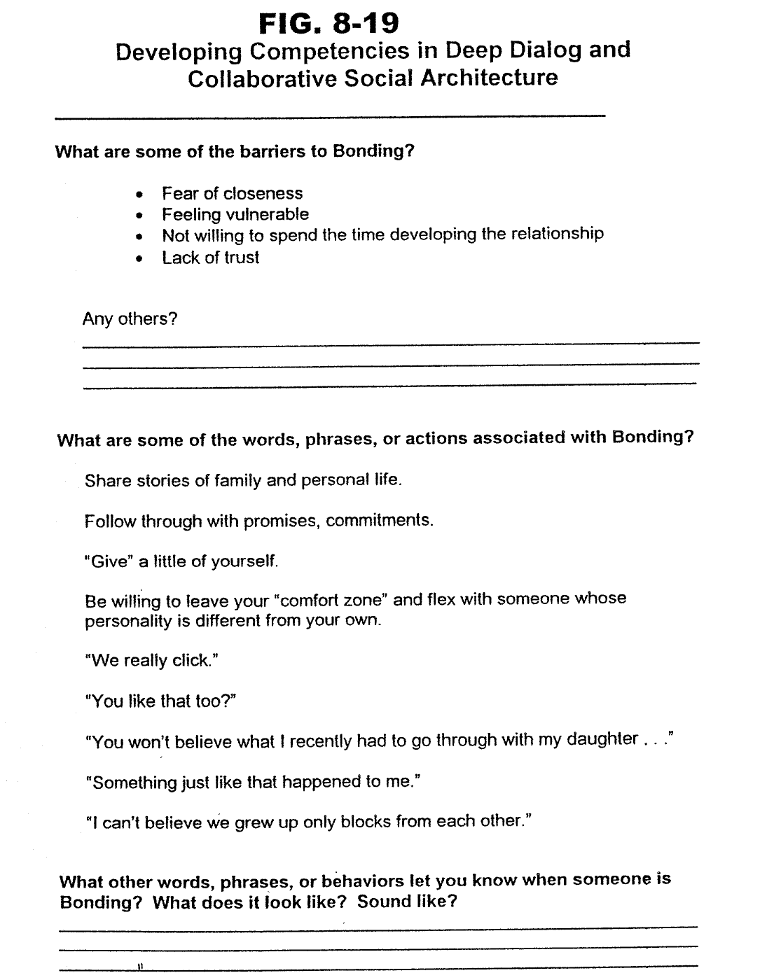

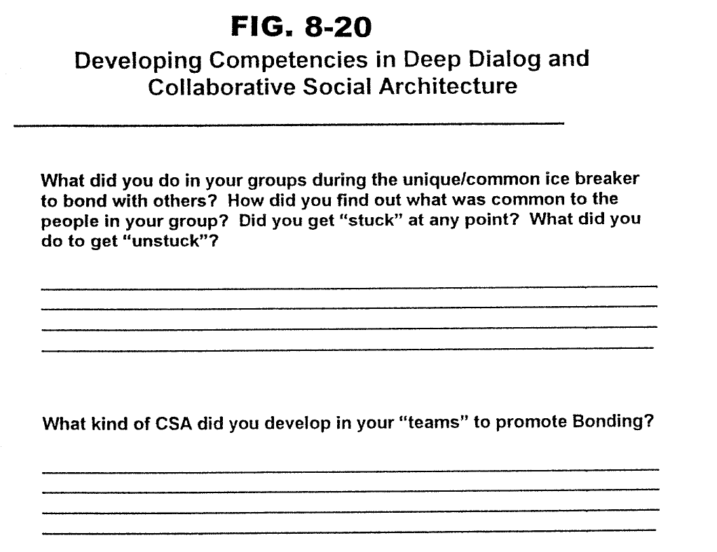

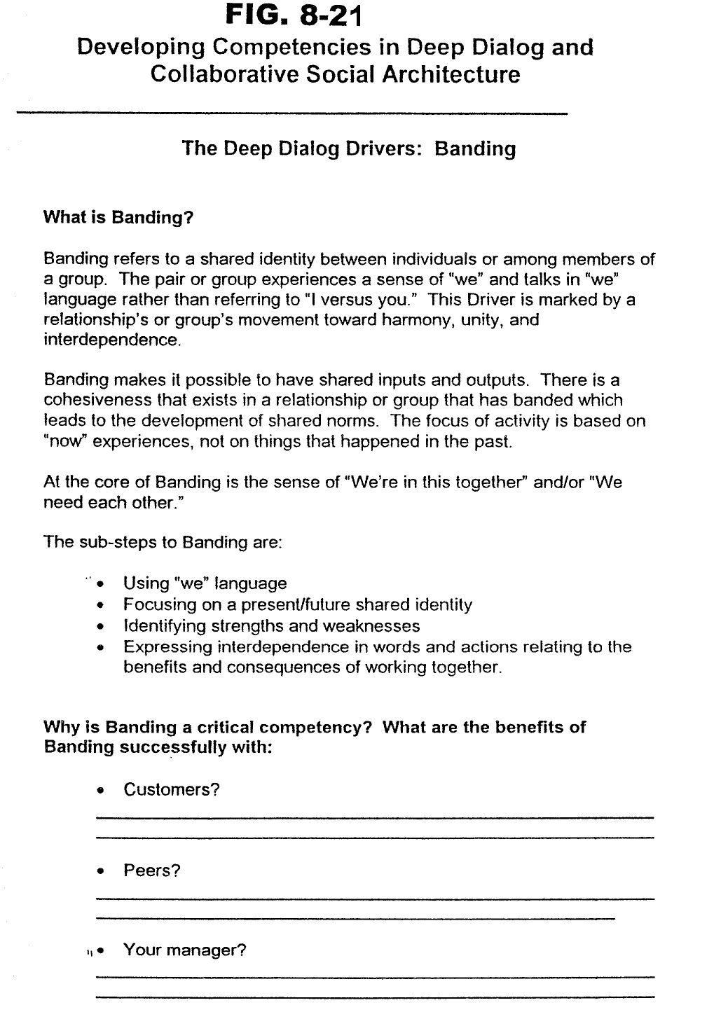

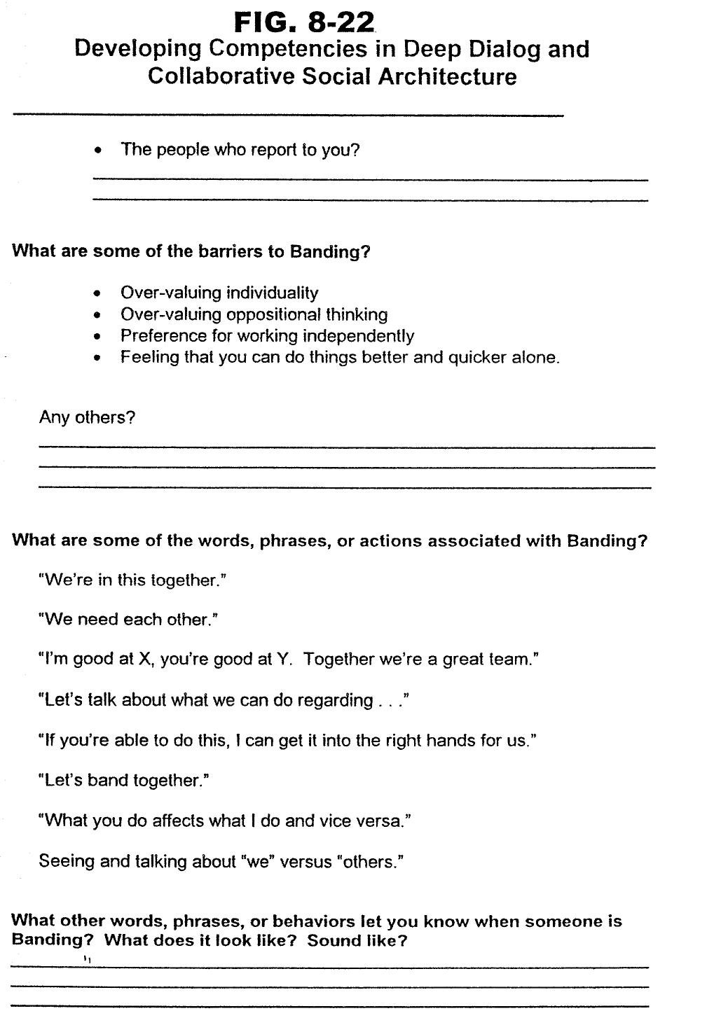

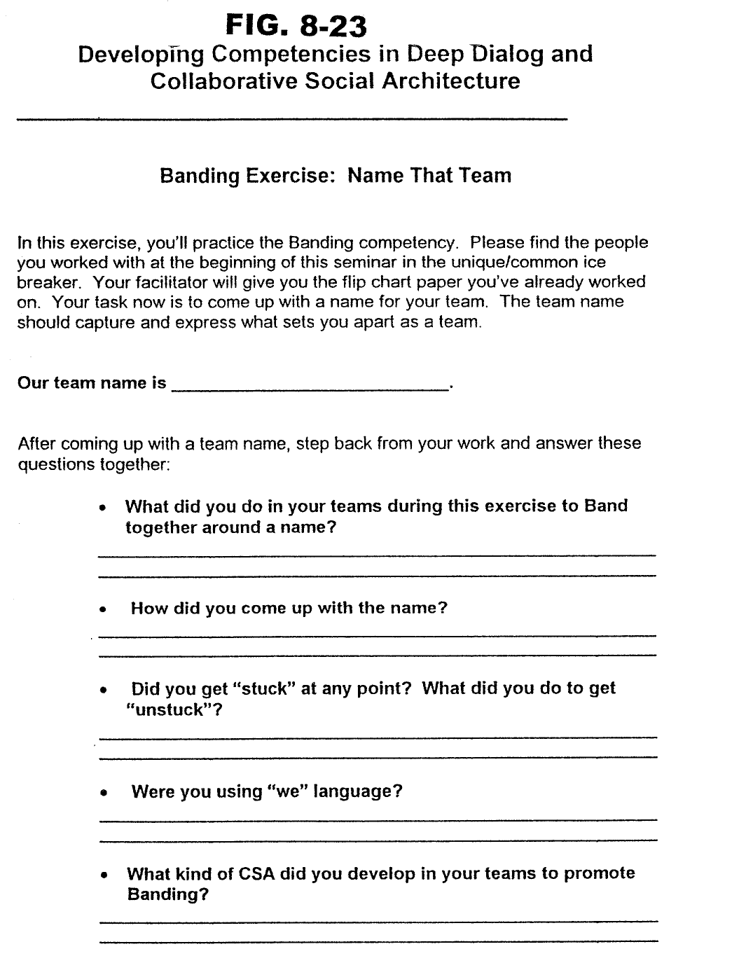

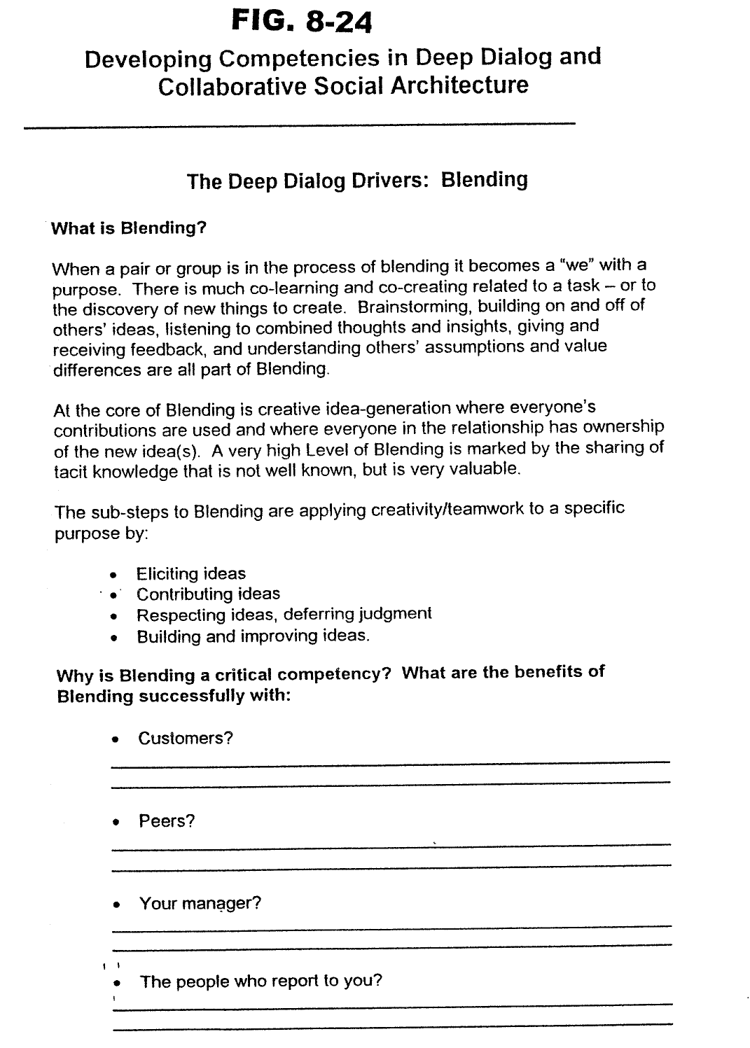

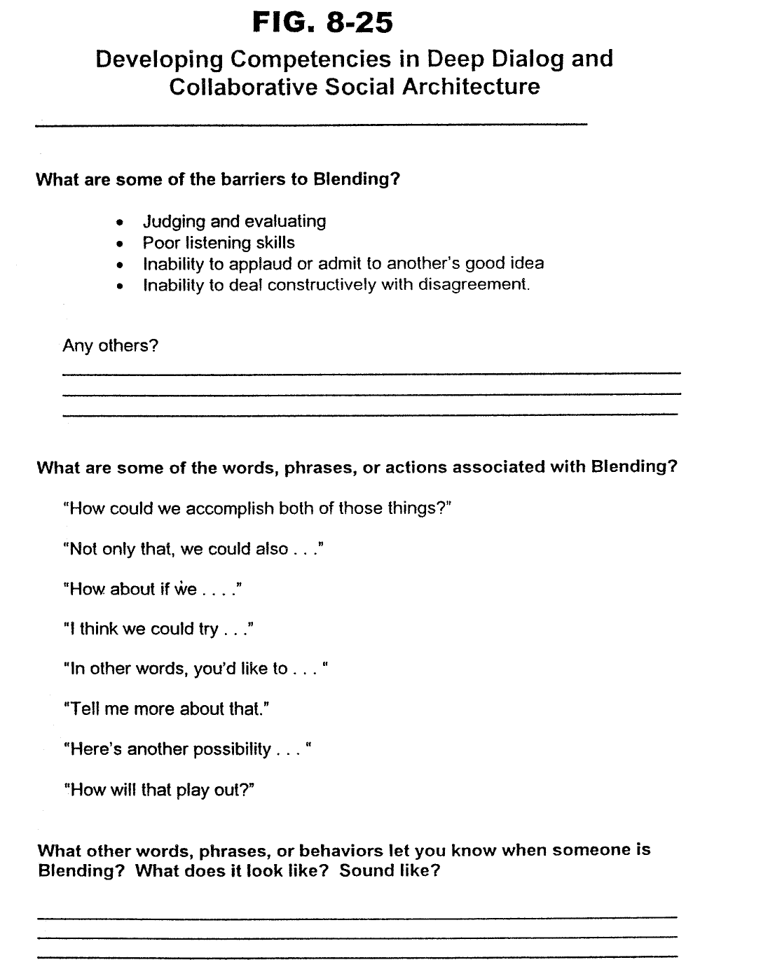

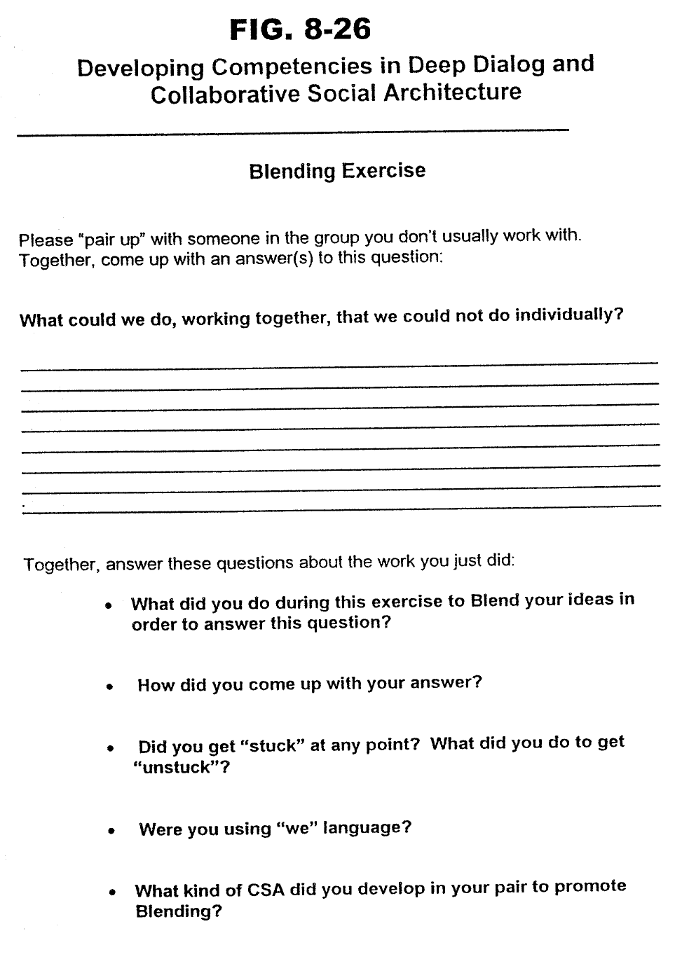

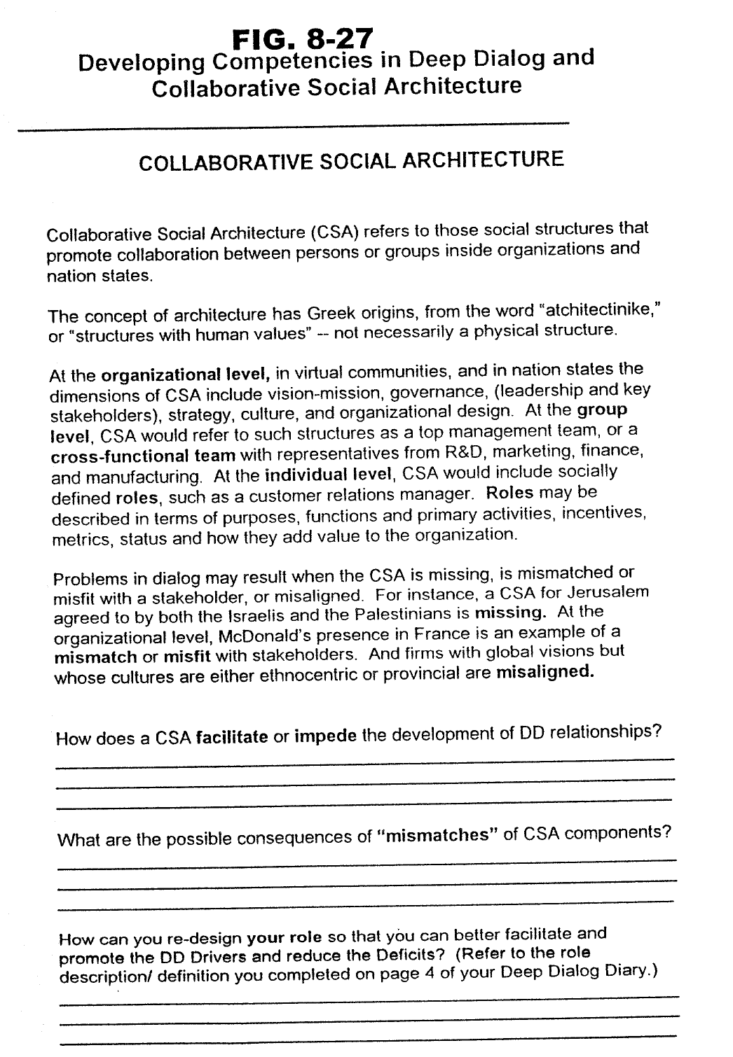

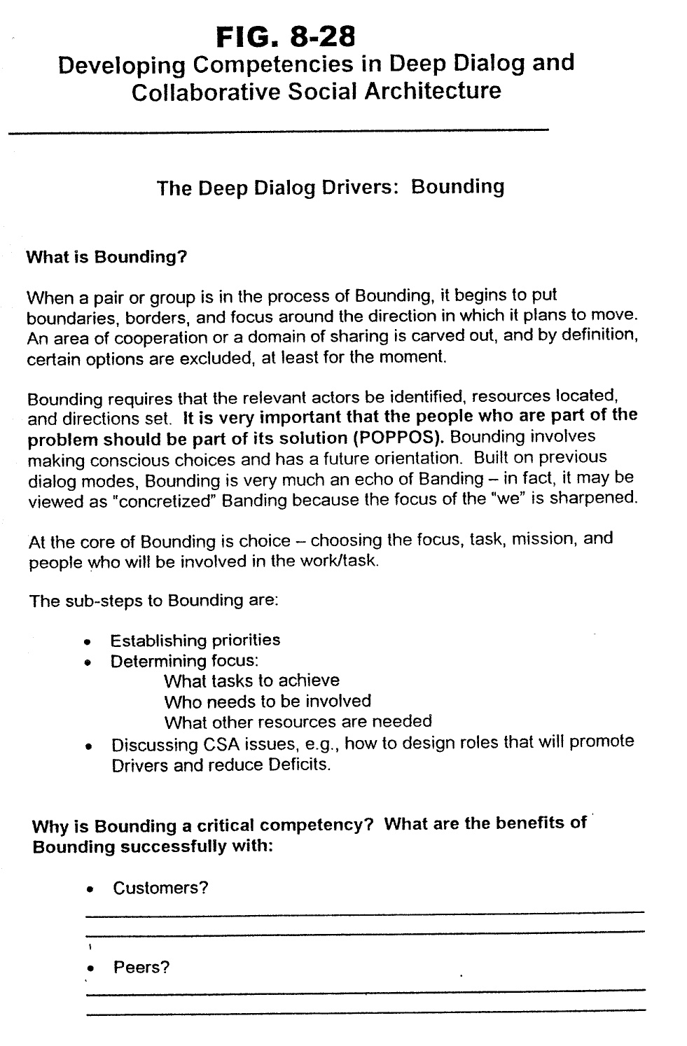

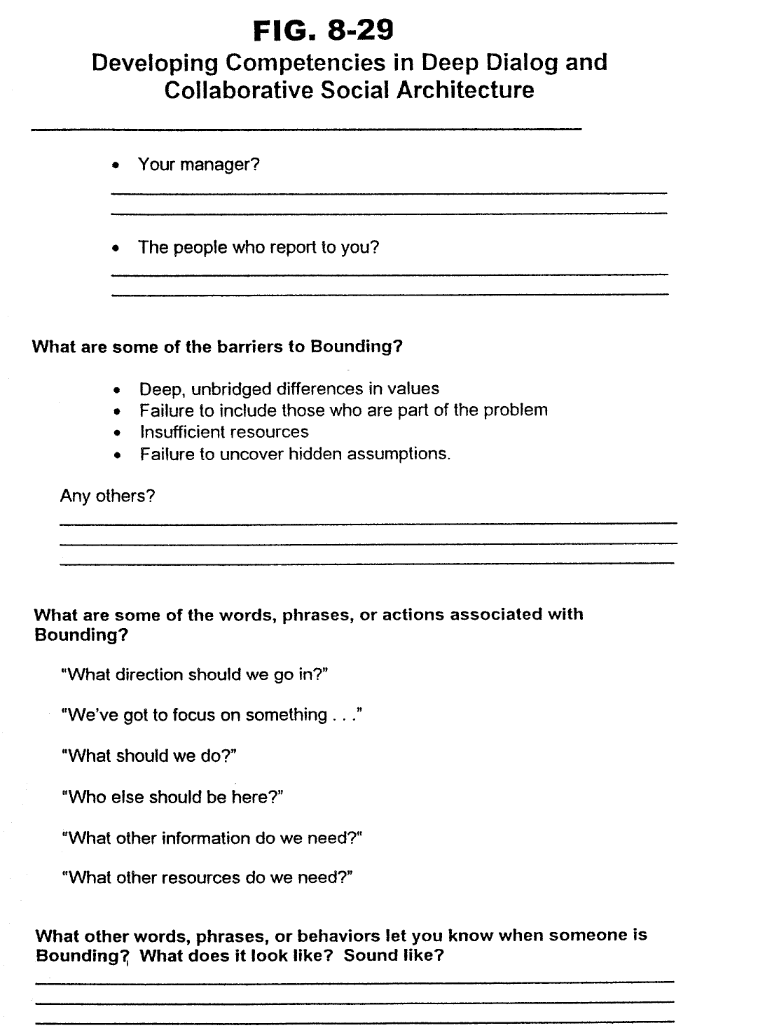

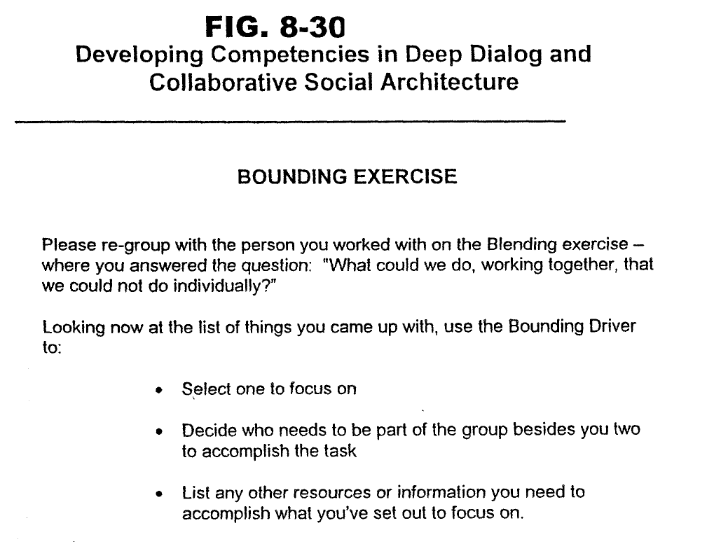

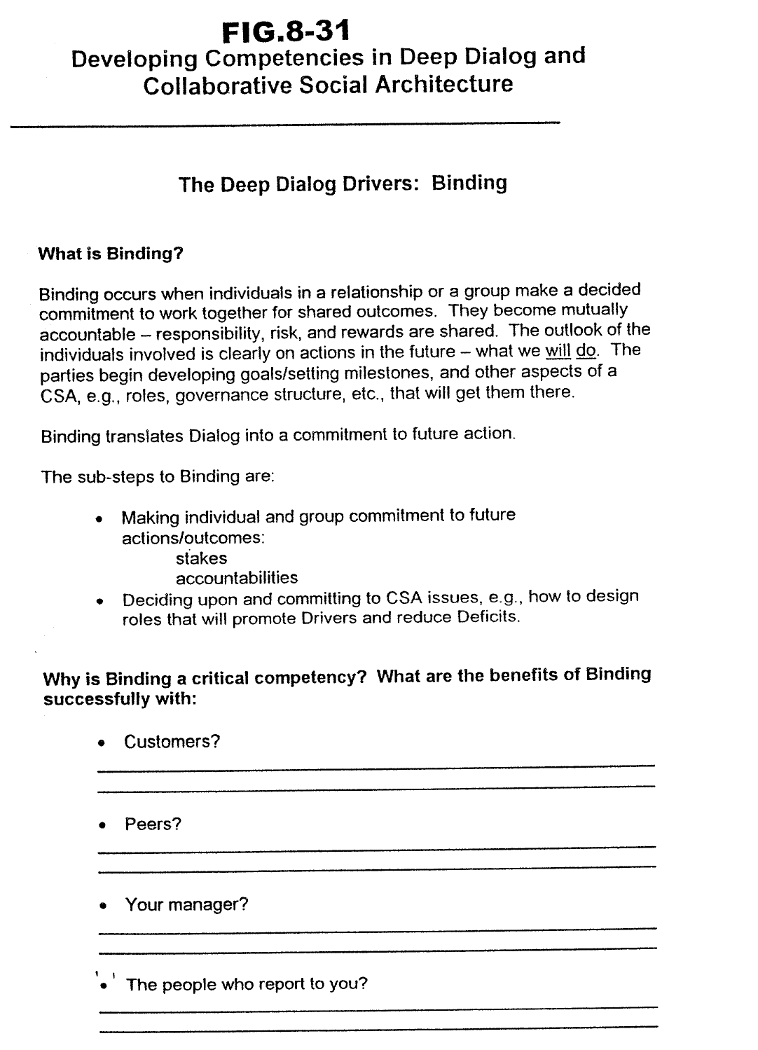

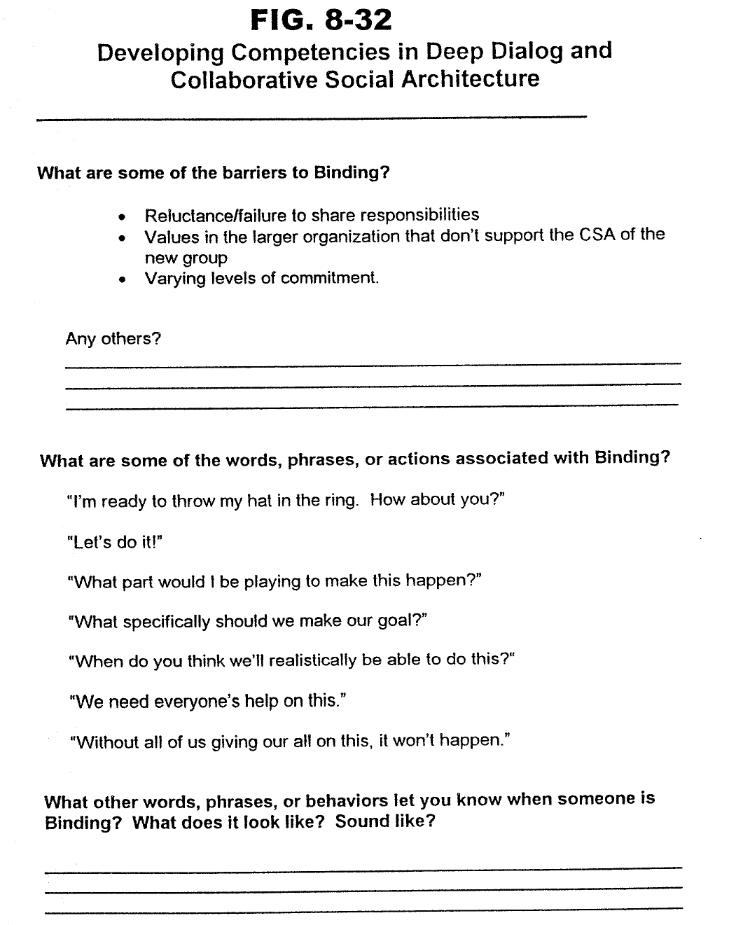

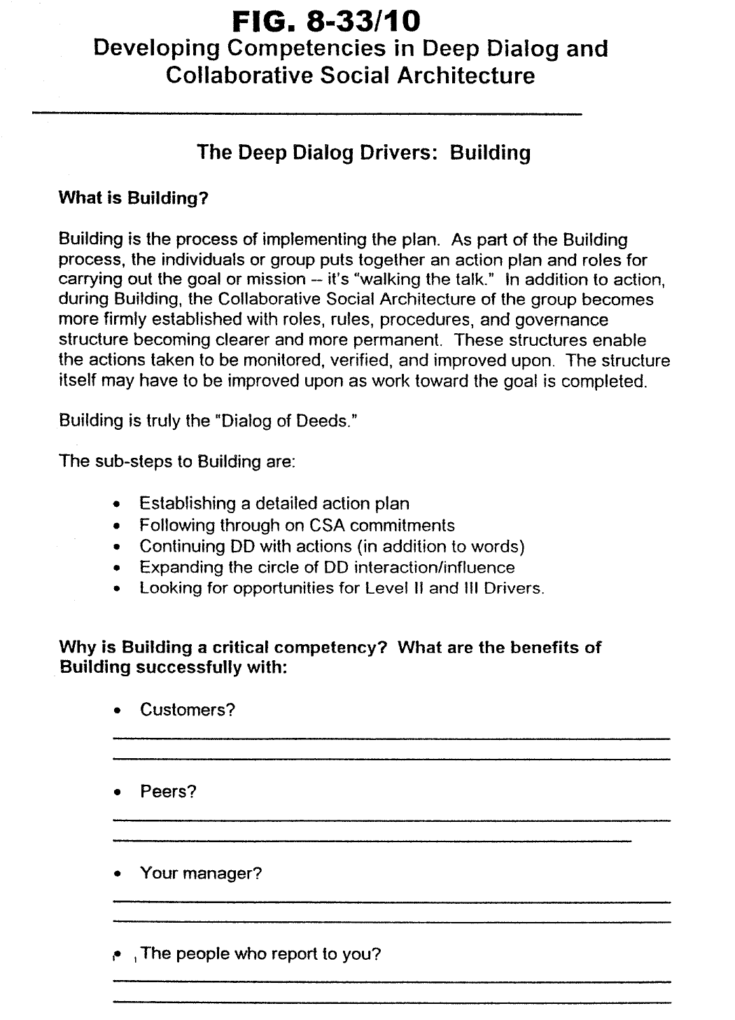

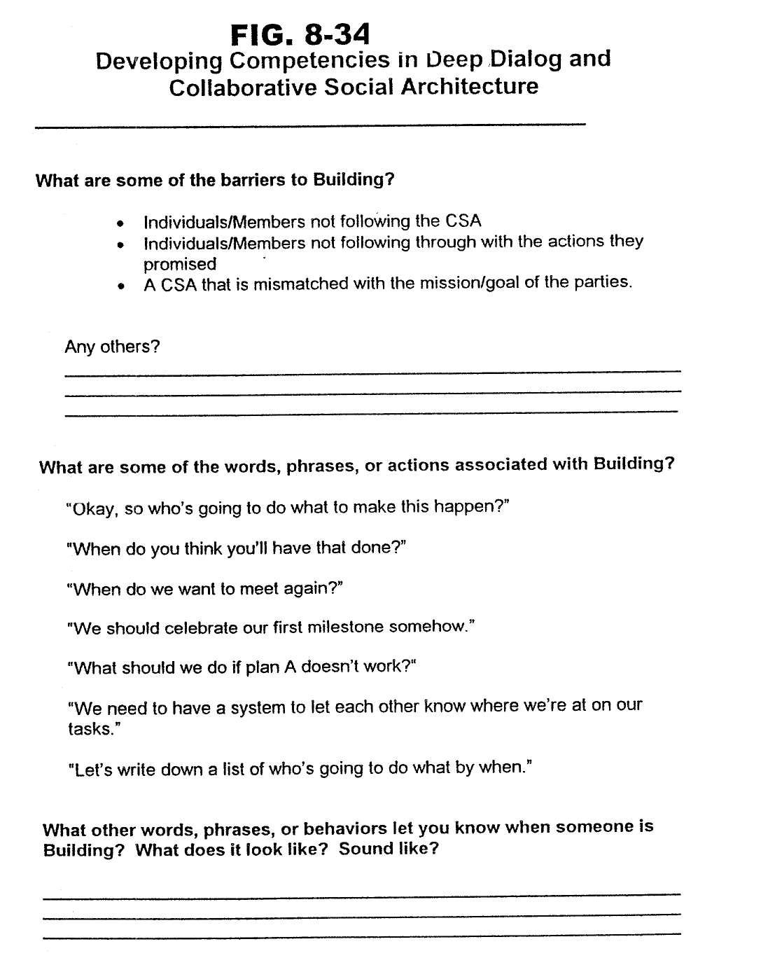

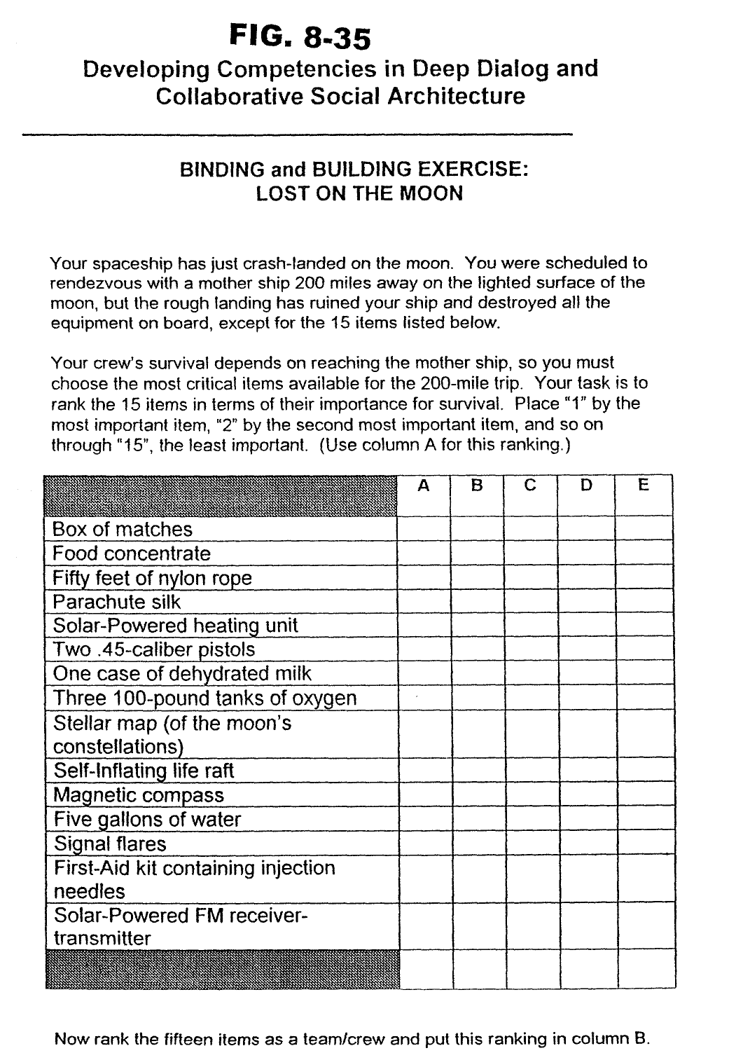

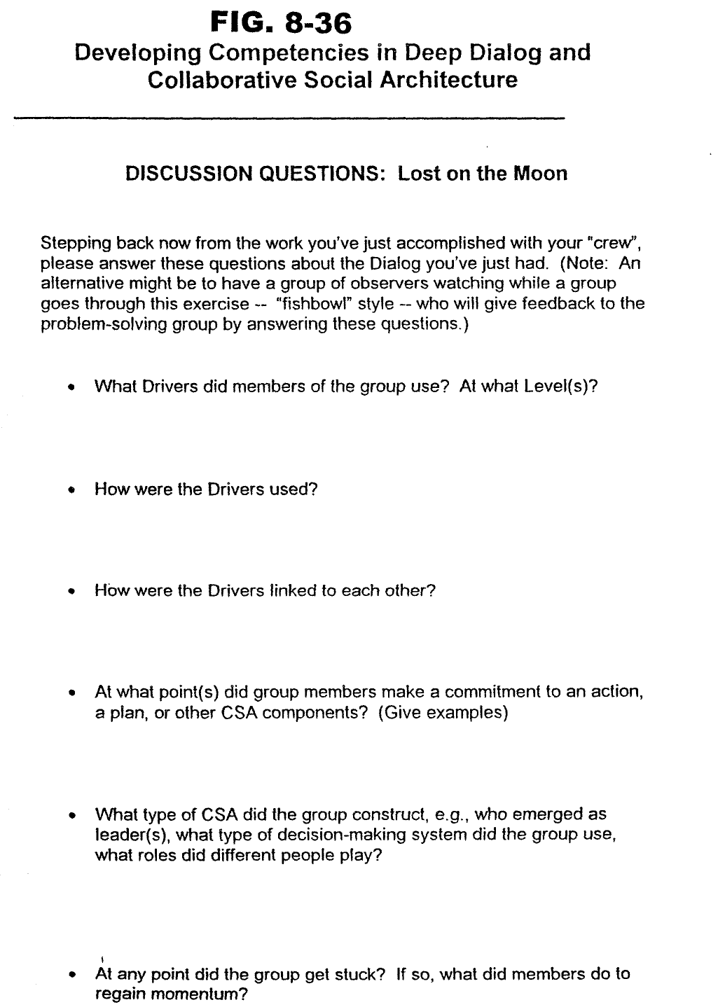

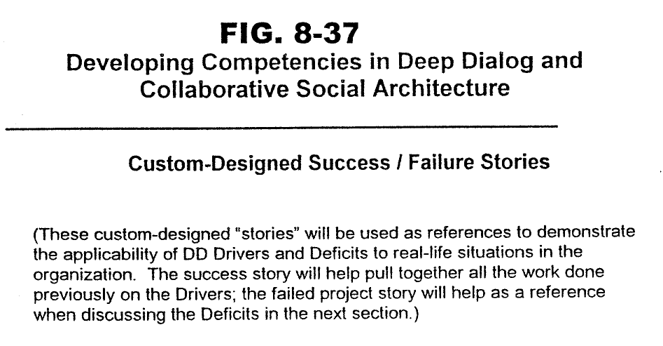

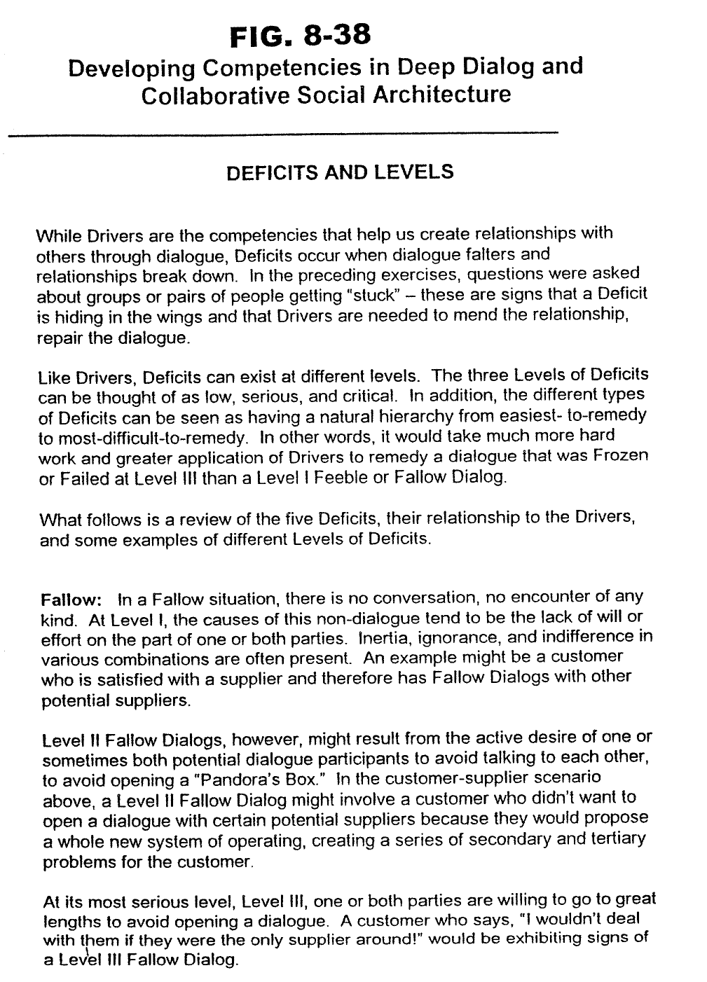

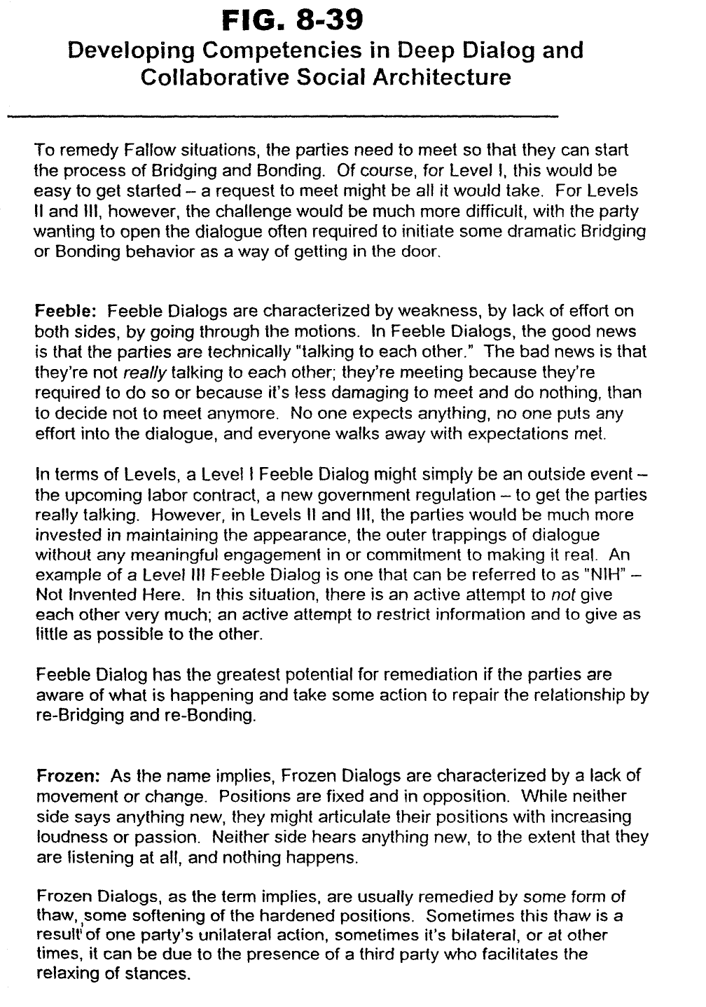

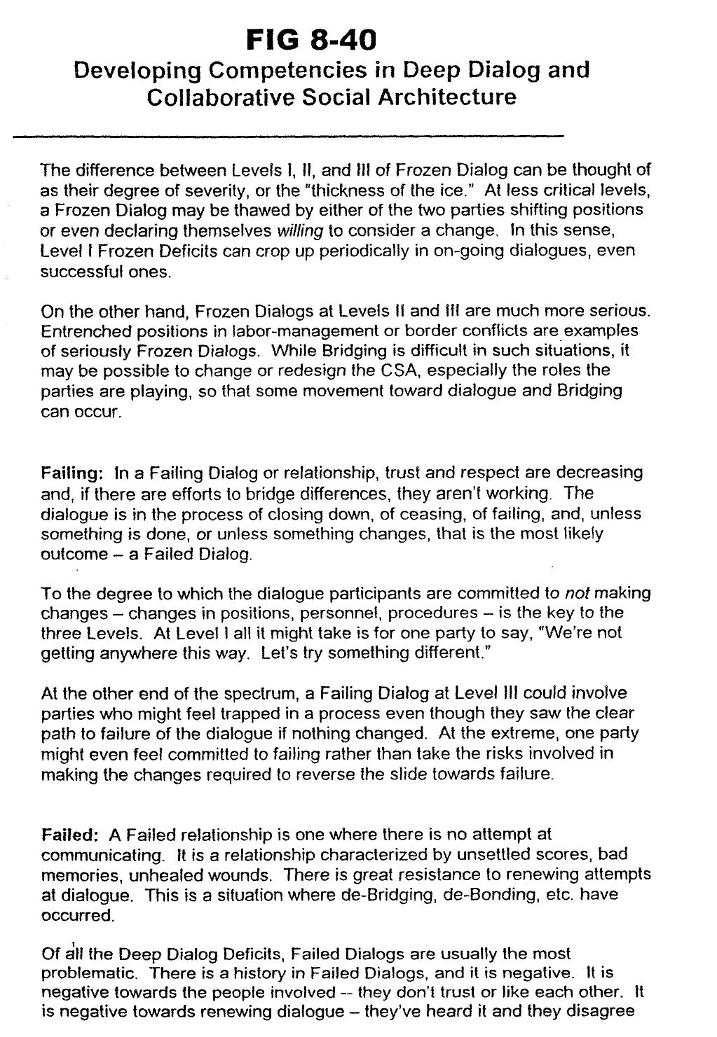

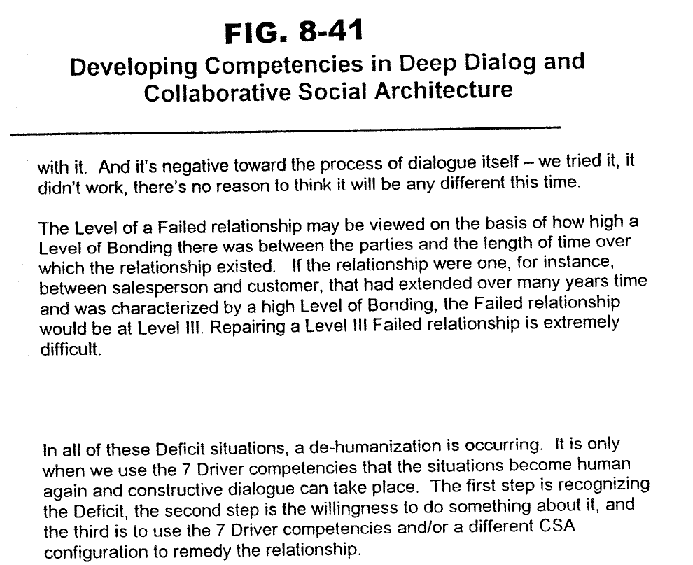

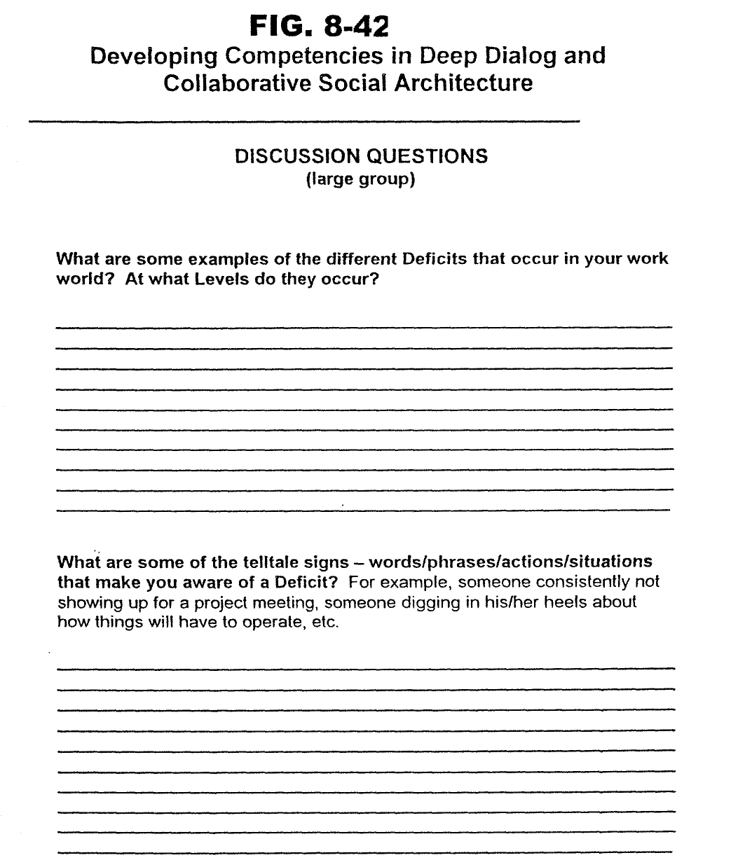

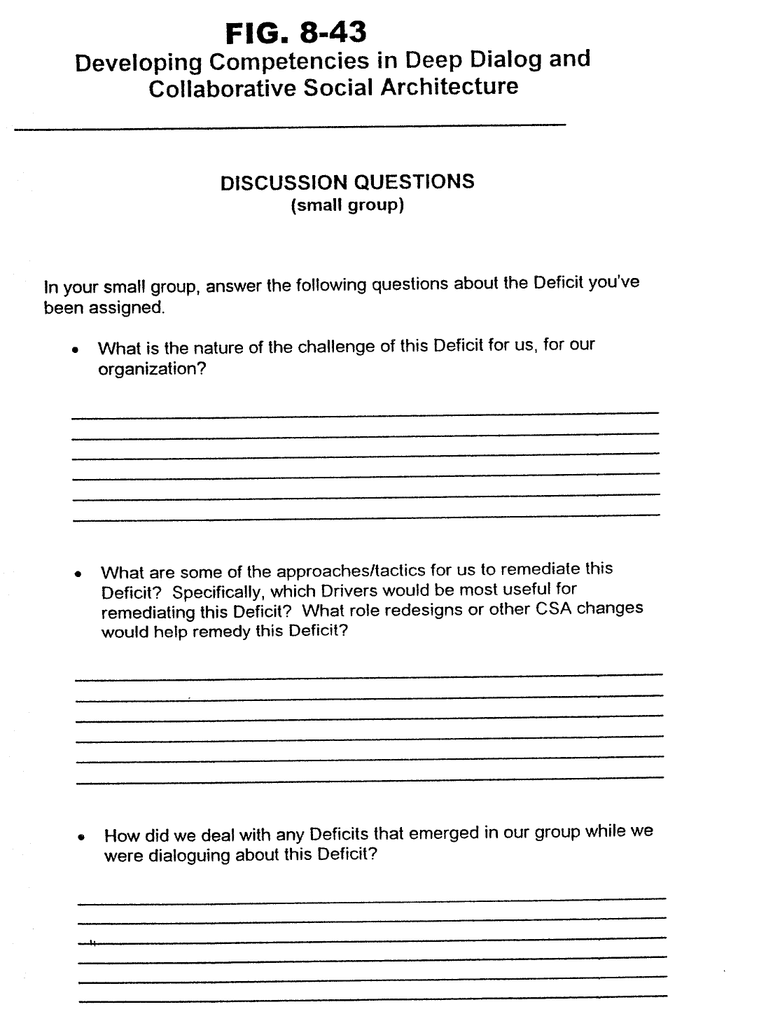

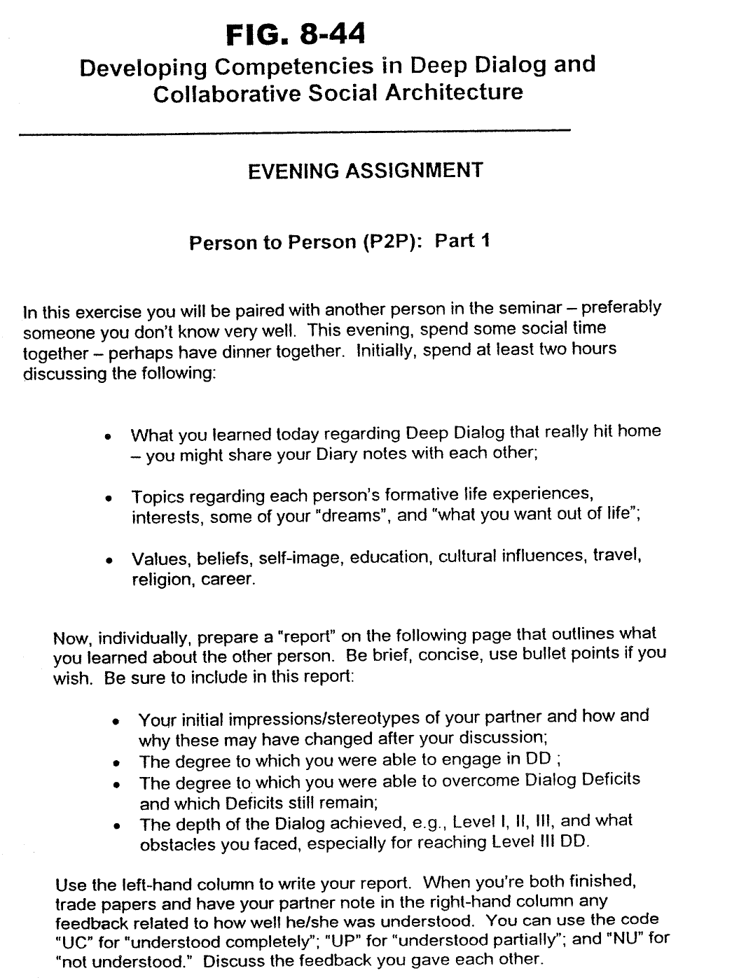

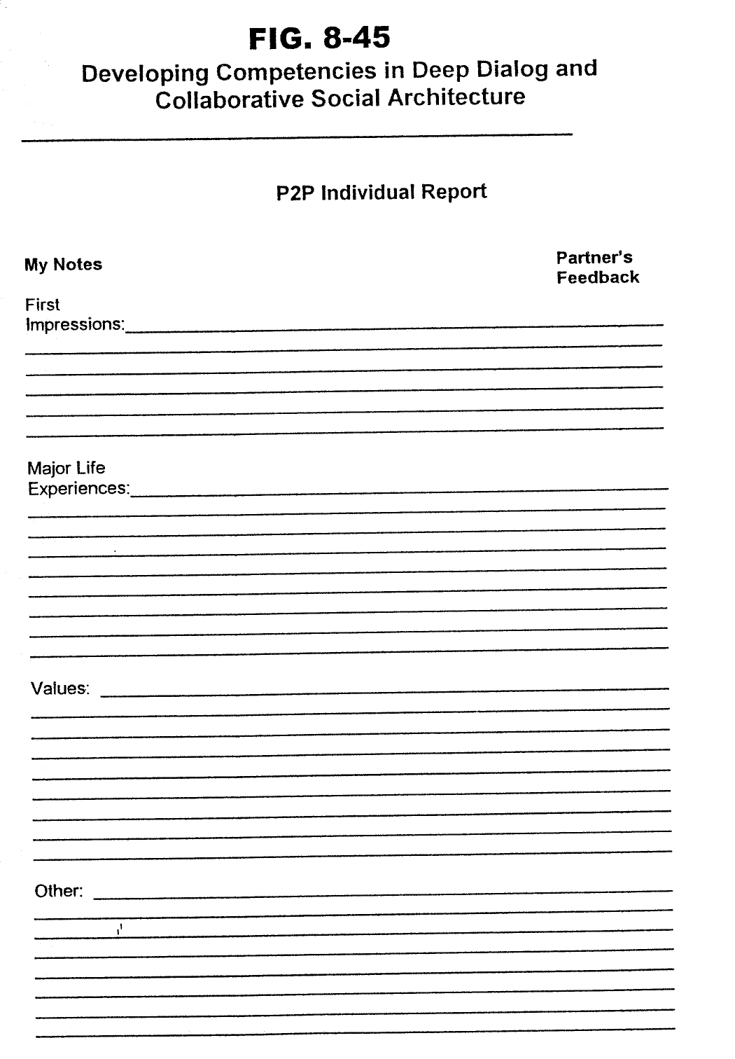

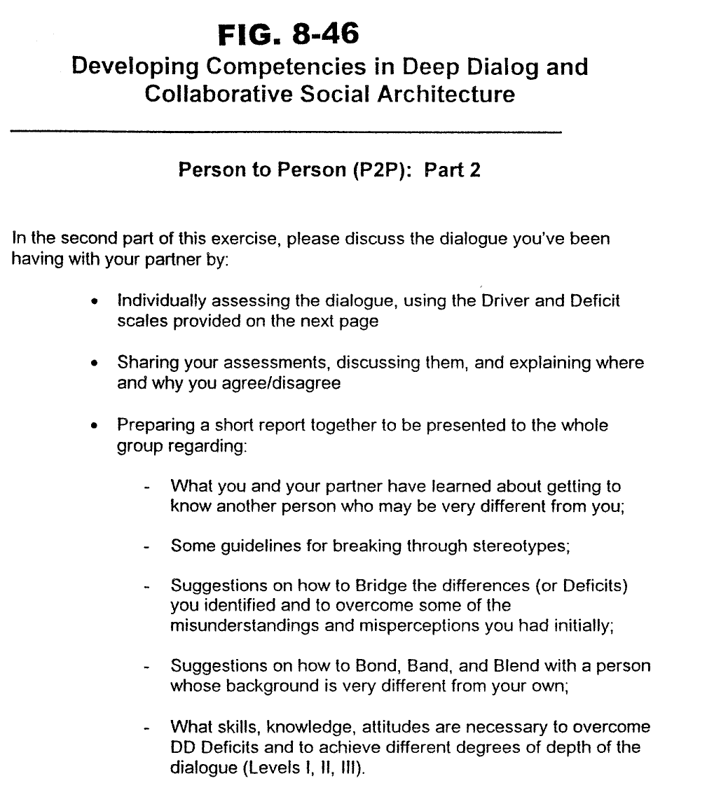

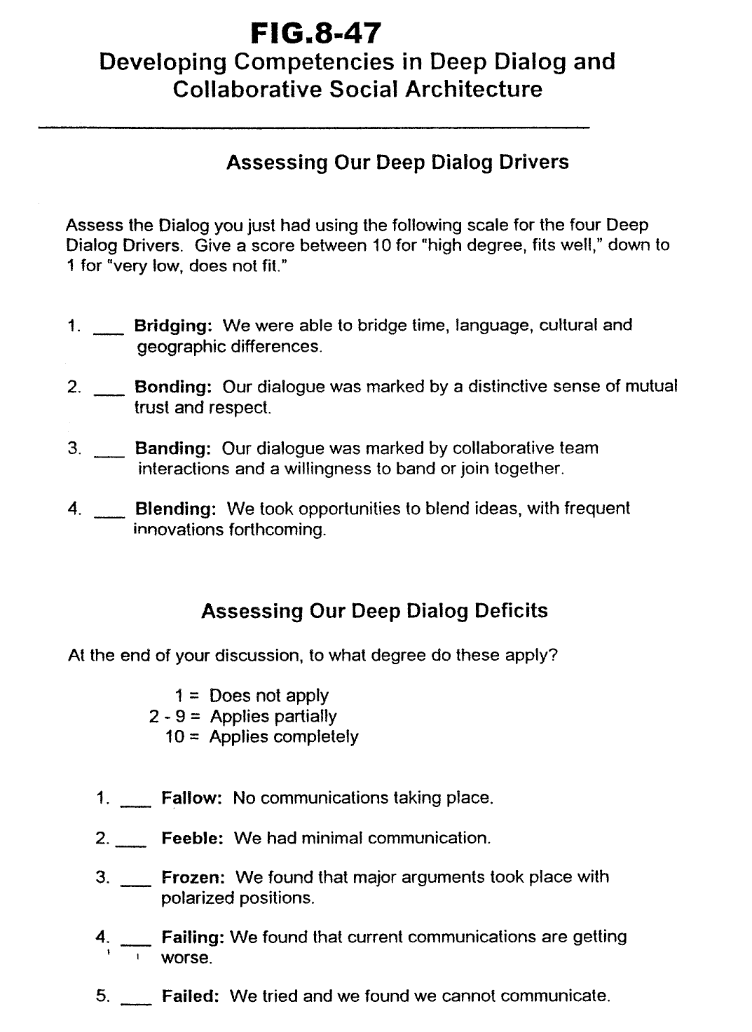

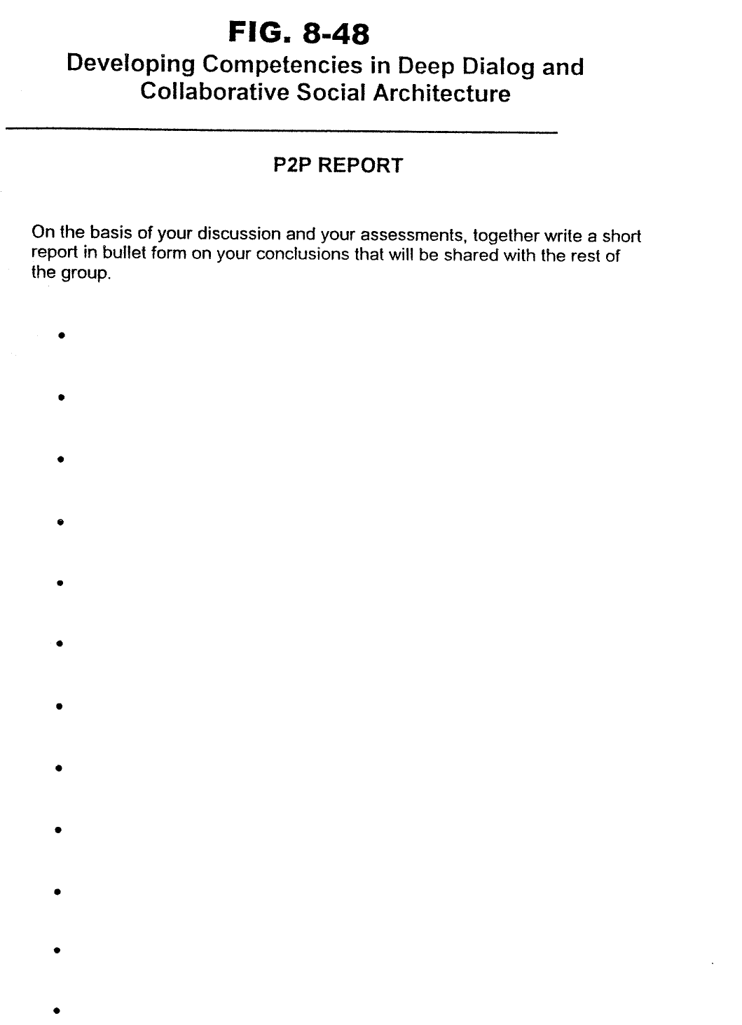

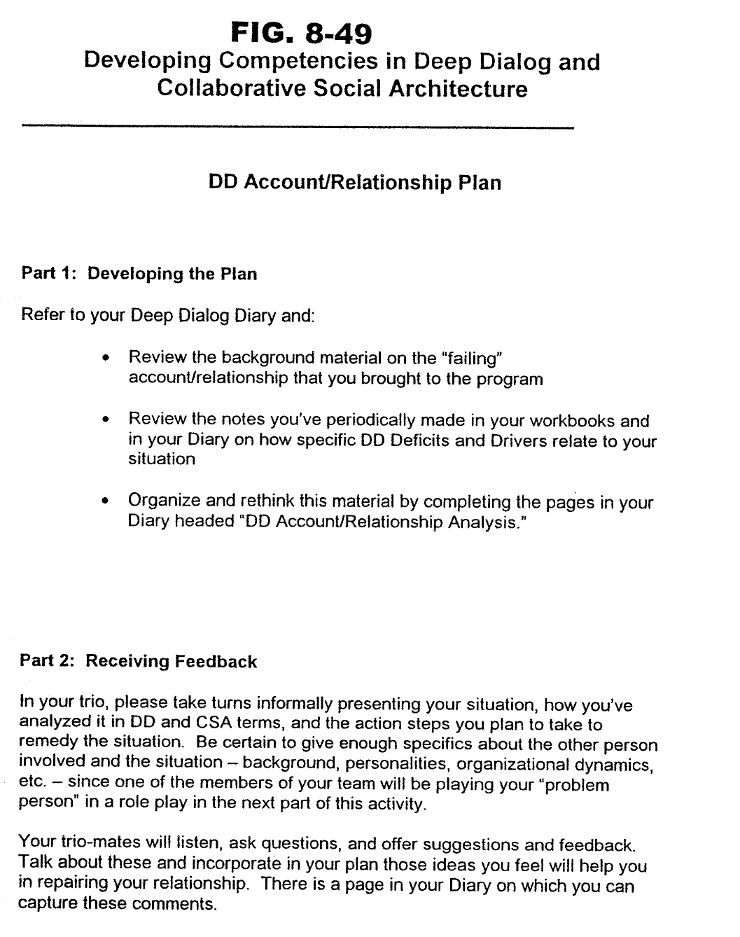

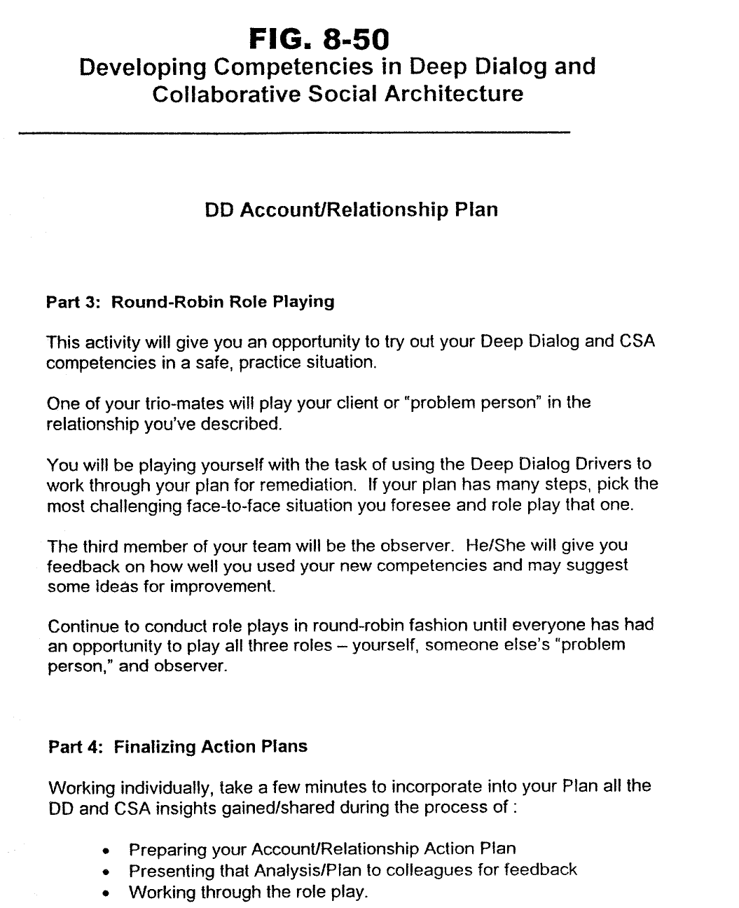

For example, the organization can educate its personnel and stakeholders, including customers, suppliers and critics both within and without the organization, in the vocabulary and concepts of the present invention. The organization can retrain, reorganize or remove persons who are obstacles to improved dialog. Preferred embodiment training and implementation materials for such an effort are attached as FIGS. 8, 9 and 10.

The organization can implement tools for organizational learning, such as “deep dialog communities.” A “deep dialog community” is a virtual community where geographically distant persons may use communications devices such as the Internet to share successes and failures without meeting face-to-face.

The organization can implement tools for improved interpersonal communication. For example, the organization can implement feedback mechanisms that allow each party to evaluate the quality of communication with another person and to provide that person with continuous feedback as a part of each communication. Such a feedback mechanism can be as simple as a block to check on an email form or as complicated as periodic, detailed reviews.

Ultimately, the organization can implement a new overall social architecture, such as to replace a hierarchical management structure with a spherical, network management structure.

The overall goal of improvements implemented by the organization is to increase the depth of communication within and without the organization and hence to implement a collaborative social architecture. The organization can evaluate the success of its endeavors by repeating the method of the present invention or by implementing mechanisms by which the organization collects feedback information to evaluate the depth of communication.

Experience has shown that survey results for an organization engaged in a successful endeavor reveal rankings of dialog drivers that are higher than the rankings of dialog drivers for an organization engaged in an unsuccessful endeavor. Similarly, experience has shown that the rankings of dialog deficits for an organization engaged in an unsuccessful endeavor are higher than the rankings of dialog deficits for an organization engaged in a successful endeavor. Experience has further shown that the differences in rankings for dialog drivers and deficits between successful and unsuccessful organizations are statistically significant, thereby validating the method of the present invention.

Many different embodiments of the above invention are possible. This application is intended to address all possible embodiments and is limited only as described in the following claims.

I claim:

1. A method for predicting the likelihood of success of an organization interaction comprising the steps of:
a. collecting communication information;
b. determining an organization profile based on said communication information;
c. predicting an outcome based on said organization profile utilizing predetermined criteria.

2. The method of claim 1, said communication information comprising information concerning a plurality of dialog drivers and a plurality of dialog deficits.

3. The method of claim 2, said dialog drivers comprising a plurality of dialog driver levels.

4. The method of claim 3, said dialog deficits comprising a plurality of dialog deficit levels.

5. The method of claim 4, said dialog driver level and said dialog deficit level defining a depth of communication.

6. The method of claim 5, said communication information comprising a plurality of answers to a plurality of questions by a plurality of persons.

7. The method of claim 6, said answers comprising a plurality of rankings of said dialog drivers and a plurality of rankings of said dialog deficits.

8. The method of claim 7, said determining an organization profile comprising extracting statistical information from said plurality of said rankings of said dialog drivers and said ranking of said dialog deficits.

9. The method of claim 8, said extracting statistical information comprising deriving a statistical mean of said plurality of responses to each of said plurality of questions.

10. The method of claim 9, said predicting of an outcome based on said organizational profile using predetermined criteria comprising comparing each of said statistical means to other of said statistical means.

11. The method of claim 10, said communication comprising communication within said organization and communication between said organization and a stakeholder without said organization.

12. A method for improving the likelihood of success of an organization interaction comprising the steps of:
a. collecting communication information;
b. determining an organization profile based in said communication information;
c. diagnosing said organization using predetermined criteria;
d. reinforcing a dialog driver;
e. decreasing a dialog deficit.

13. The method of claim 12, said communication information comprising information concerning a plurality of said dialog drivers and a plurality of said dialog deficits.

14. The method of claim 13, said dialog drivers comprising a plurality of dialog driver levels.

15. The method of claim 14, said dialog deficits comprising a plurality of dialog deficit levels.

16. The method of claim 15, said dialog driver level and said dialog deficit level defining a depth of communication.

17. The method of claim 16, said communication information comprising a plurality of answers to a plurality of questions by a plurality of persons.

18. The method of claim 17, said answers comprising a plurality of rankings of said dialog drivers and a plurality of rankings of said dialog deficits.

19. The method of claim 18, said determining an organization profile comprising extracting statistical information from said plurality of said rankings of said dialog drivers and said plurality of said rankings of said dialog deficits.

20. The method of claim 19, said extracting statistical information comprising deriving a statistical mean of said plurality of responses to each of said plurality of questions.

21. The method of claim 20, said diagnosing of an organization comprising comparing each of said statistical means to other of said statistical means.

22. The method of claim 21, said reinforcing said dialog driver and said decreasing said dialog deficit comprising taking steps to increase said depth of communication.
